(19) United States
(12) Patent Application Publication
(10) Pub. No.: US 2010/0004944 A1
(43) Pub. Date: Jan. 7, 2010

(54) Book Creation In An Online Collaborative Environment

(76) Inventor: Murugan Palaniappan, Saratoga, CA (US)

Correspondence Address: Ashok Tankha, 36 Greenleigh Drive, Sewell, NJ, 08080, US

(21) Appl. No.: 12/487,683

(22) Filed: Jun. 19, 2009

Related U.S. Application Data
(60) Provisional application No. 61/078,451, filed on Jul. 7, 2008.

(51) Int. Cl. G06Q 99/00; G06F 17/00; G06F 17/30

(52) U.S. Cl. 705/1; 715/235; 707/10; 707/5; 707/203; 707/E17.108; 707/E17.008

(57) ABSTRACT

A computer implemented method and system is provided for compiling and publishing an online book in an online collaborative environment. Requirements are collected from one or more users in the online collaborative environment. The collected requirements comprise, for example, educational subjects, topical subjects, information on syllabus, an outline, etc. One or more content structures are created based on the collected requirements using, for example, one or more of search criteria, applicable context, curriculum guidelines, curriculum standards, degrees of difficulty, etc. The educational content is retrieved from multiple online sources, created through authoring, or a combination thereof. The retrieved educational content is compiled into the content structures for creation of the online book. The compilation is performed by automatic compilation or user declared specification. The online book is then published in the online collaborative environment. The published online book may be printed to obtain a printed physical book.

### CROSS REFERENCE TO RELATED APPLICATIONS

This application claims the benefit of provisional patent application No. 61078451 titled “Book Creation In An Online Collaborative Environment”, filed on Jul. 7, 2008 in the United States Patent and Trademark Office.

### BACKGROUND

The computer implemented method and system disclosed herein, in general, relates to web based book creation. More particularly, the computer implemented method and system disclosed herein relates to compiling and publishing an online book in an online collaborative environment.

Any form of content, whether informational or educational, has traditionally been provided in a standardized book format. The content thus provided cannot be altered or customized. Finding content based on a particular need of a user can be difficult if there is a large collection of content that spans numerous books, articles, publications, periodicals, etc. Also, with the rapid pace of development and advent of new concepts, the content in books becomes obsolete and incomplete. Correcting the content in a published book requires a substantial amount of time and expense. Content found online through assorted search engines is usually stored in smaller segments or files, and is much easier to search for compared to content found in books. Here again, there are many links which have to be followed to gather content required by the particular user. Also, the online content may not always be sufficient or relevant and a large amount of time is required to search, choose, format, and assemble the required content into a hard copy format.

Hence, there is a need for an online collaborative environment that retrieves educational content based on requirements of one or more users. There is also a need for compiling the retrieved educational content for creation of the online book as per the requirements of one or more users and publishing the online book in multiple formats, for example, a printed paper book. There is also a need for rating, reviewing, recommending, and sharing the published online book within a social network.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated needs for an online collaborative environment that compiles and publishes an online book. The computer implemented method and system disclosed herein further enables rating, reviewing, recommending, and sharing of the published online book within a social network.

Requirements are collected from one or more users for compilation of educational content in the online collaborative environment. The requirements collected from the users comprise, for example, one or more of educational subjects, topical subjects, information on syllabus, and an outline. One or more content structures are created based on the collected requirements. The content structures are created using, for example, one or more of search criteria, applicable context, curriculum guidelines, curriculum standards, degrees of difficulty, etc. The educational content is retrieved from multiple online sources, created through authoring, or a combination thereof. The educational content comprises authored educational content, preexisting online educational content, multimedia learning objects, or a combination thereof.

The online collaborative environment allows the users to author educational content for inclusion into the online book. The educational content is authored by, for example, single user authoring or collaborative authoring. Authoring is performed based on formatting instructions and structuring instructions provided in the online collaborative environment. The online collaborative environment gathers educational content from multiple federated repositories pre declared by the users. The online collaborative environment also uploads the educational content provided by the users. The uploaded educational content is stored in a micro module database and translated by the online collaborative environment. The educational content is translated based on, for example, one or more of content, figure, legend, exercise, answer, etc.

The online collaborative environment maintains parallel versions and sequential versions of the retrieved educational content and the authored educational content. The online collaborative environment enables certification, endorsement, and adaptation of the retrieved educational content for derivative or individualized need basis. The online collaborative environment further enables collation of the retrieved educational content into different sections based on explicit themes and implicit themes.

The retrieved educational content is compiled into the content structures for creation of the online book. The compilation of the retrieved educational content into the content structures is performed by automatic compilation or user declared specification. The online collaborative environment enables masking of unsuitable educational content during the compilation of the retrieved educational content.

The online book is then published in the online collaborative environment. The online collaborative environment enables the users to rate, review, recommend, and share the published online book within a social network. The online collaborative environment also allows the users to create, manage, and share endorsements in the social network. The online collaborative environment allows user interaction related to content of the published online book. The published online book is manifested in multiple formats. One of the formats is, for example, a printed physical book.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of compiling and publishing an online book in an online collaborative environment.

FIG. 2 illustrates a computer implemented system for compiling and publishing an online book in an online collaborative environment.

FIG. 3 exemplarily illustrates architecture of the online collaborative environment.

FIG. 4 exemplarily illustrates the lifecycle of compiling the educational content into the online book.

FIG. 5 exemplarily illustrates a flowchart for compiling and publishing the online book in the online collaborative environment.

FIG. 6 exemplarily illustrates functional modules of open authoring and collaborative authoring in the online collaborative environment.

FIG. 7 exemplarily illustrates a schematic flow of a computer implemented method of compiling and publishing an online book in an online collaborative environment.

FIG. 8 exemplarily illustrates the architecture of a computer system employed in a content collaboration server.

FIG. 9 exemplarily illustrates a content page of an online book created in the online collaborative environment.

FIG. 10 exemplarily illustrates a content page of a published printed book created in the online collaborative environment.

FIG. 11 exemplarily illustrates a webpage comprising educational content retrieved using the online collaborative environment.

FIGS. 12A-12G exemplarily illustrate a reduced set of instruction code used for authoring content in the online collaborative environment.

FIG. 13 exemplarily illustrates a sample code used to define a content structure comprising content modules and elements.

FIG. 14 exemplarily illustrates the process involved in creating an online book by aggregating one or more content structures.

FIGS. 15A-15B exemplarily illustrate creation of a sample element in a content structure.

FIG. 15C exemplarily illustrates a sample content module defined by elements in a content structure.

FIG. 15D exemplarily illustrates a page of an online book created by logical aggregation of content structures.

FIG. 16 exemplarily illustrates the content structures displayed in the online collaborative environment for creation of the online book.

### DETAILED DESCRIPTION OF THE INVENTION

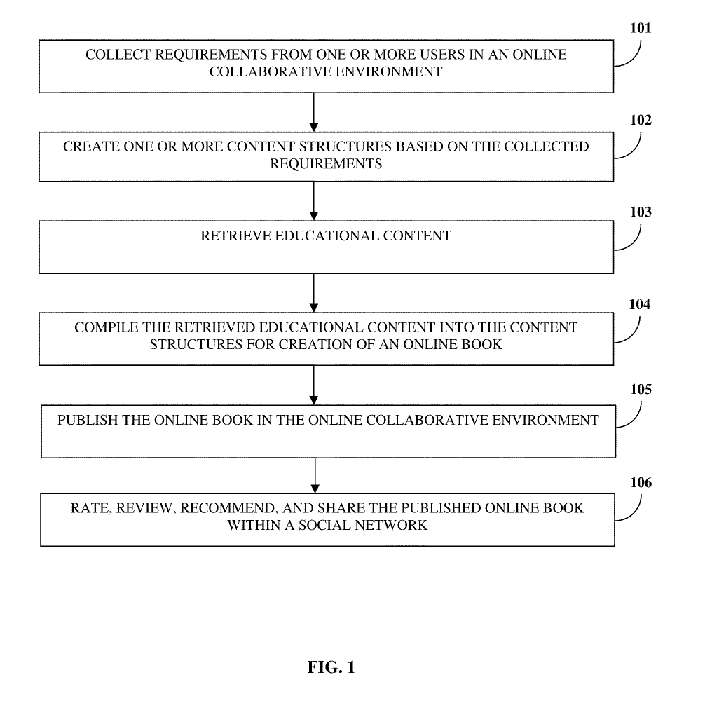

FIG. 1 illustrates a computer implemented method of compiling and publishing an online book in an online collaborative environment. As used herein, the term “online collaborative environment” refers to an environment that incorporates a platform accessed by multiple users for collaborative activities and interactions. Requirements are collected 101 from one or more users in the online collaborative environment. The collected requirements comprise, for example, one or more of educational subjects, topical subjects, information on syllabus, and an outline. One or more content structures are created 102 based on the collected requirements. The content structures are created using, for example, one or more of search criteria, applicable context, curriculum guidelines, curriculum standards, keywords, degree of difficulty, etc.

Educational content is retrieved 103 from multiple online sources, created through authoring, or a combination thereof. The educational content comprises, for example, educational content authored by the users, preexisting online educational content, multimedia learning objects, or any combination thereof.

For an originally authored online book, the online collaborative environment allows the users to author educational content for inclusion into the online book. The authoring is, for example, single user authoring or collaborative authoring. As used herein the term “single user authoring” refers to authoring of educational content by a single user and “collaborative authoring” refers to authoring of educational content by multiple authors as a team. The authoring is performed based on formatting instructions and structuring instructions provided in the online collaborative environment. The users author the educational content, revise the educational content, and modify the educational content in the online collaborative environment. For example, a teacher, who wants to create a course on “thermodynamics”, may chart out the lesson plan and course materials that cover heat, laws of thermodynamics, heat and mass transfer, enthalpy, entropy, etc. For an online book with preexisting content, a search is performed based on different requirements collected from the users. For example, a student interested in learning more about “optics” may search for “advanced topics on optics” in the online collaborative environment. The online collaborative environment will list topics on dispersion, total internal reflection, spectrometry, laser physics, etc., to the student.

The online collaborative environment gathers educational content from multiple federated repositories pre declared by the users. The online collaborative environment also uploads the educational content provided by the users. The uploaded educational content is stored in a micro module database and translated by the online collaborative environment. The educational content is translated based, for example, on one or more of content, figure, legend, exercise, answer, etc.

The content structures are defined by content modules and elements. As used herein, “element” refers to a container for logical grouping of text or resources. Also, as used herein “content module” refers to a group of elements in sequential and formatted layouts. The retrieved educational content is transformed, reviewed, and represented as content modules. The content modules are the lowest granular form of the content structures that may be used during the compilation of the online book. The content modules are refined into elements. The content modules are either a single content module or a combination of elements with annotations attached. The educational content authored by the users and the retrieved educational content is compiled after review by administrators, editors, and volunteer approvers in the online collaborative environment to maintain the quality of the educational content.

The retrieved educational content is compiled 104 into the content structures for creation of the online book. A logical aggregation of the content structures results in the creation of the online book. The online book is created using both the retrieved educational content and/or the educational content authored by the users. Unsuitable educational content for a respective manifestation format is masked during the compilation of the retrieved educational content. The compilation of the retrieved educational content is performed by automatic compilation or performed based on user declared specification. Automatic compilation is performed by the online collaborative environment using the content structures. The compilation based on user declared specification is performed manually by the users.

The online collaborative environment enables collation of the retrieved educational content into different sections based on explicit themes and implicit themes, for example, table of contents, index, glossary, etc. The online collaborative environment provides one or more tools, for example, What You See Is What You Get (WYSIWYG) tools for editing and collating operations to be performed on the retrieved educational content. The educational content further comprises, for example, multimedia learning objects (MLOs) that are a combination of video, audio, images, and texts synchronized to provide interactive learning. The online collaborative environment also maintains parallel versions and sequential versions of the retrieved educational content and the authored educational content. The online collaborative environment enables certification, endorsement, and adaptation of the retrieved educational content.

The online book is then published 105 in the online collaborative environment. The online collaborative environment provides infrastructure services comprising single sign-on for authentication and authorization, internationalization for publishing the online book in different languages, versioning for maintaining concurrent versions or adaptations of derived educational content, and meta-tagging for associating descriptive information with the educational content. The published online book is manifested in multiple formats. One of the formats is, for example, a printed physical book. The online book may also be bilingual. The bilingual online book comprises, for example, content in one language and the corresponding translation. Customized books with blank pages for taking notes on one side with textbook content on another side may also be published.

Furthermore, the online collaborative environment enables the users to rate, review, recommend, and share 106 the published online book within a social network. The online collaborative environment allows creation, management, and sharing of endorsements in the social network. The online collaborative environment also enables user interaction, for example, online book reviews, authored reviews, content module reviews, discussions, performing book clubbing activities, etc. related to content of the published online book. The online collaborative environment further provides annotation tools for commenting on endorsements. The online collaborative environment provides a sharing utility.

The online collaborative environment allows the educational content to be easily available. The online collaborative environment allows the users, for example, students, teachers, professionals, authors, parents, school system administrators, etc., to individualize the online book according to desired requirements and publish the online book, thereby cutting costs of producing the online book. The online collaborative environment is adaptable to individual and community needs. The online collaborative environment provides administration and self guided technical support to the users in the online collaborative environment. The online collaborative environment also provides metadata management, self support discussion forum management, and real time internet chat management for enabling the users to interact with each other and share information. The online collaborative environment also provides a run time environment for executing application modules comprising language runtime environments, for example Java, Python, C, etc., and application services based on service oriented architecture using representational state transfer (REST) based application programming interfaces (APIs) for loosely coupled federated application services.

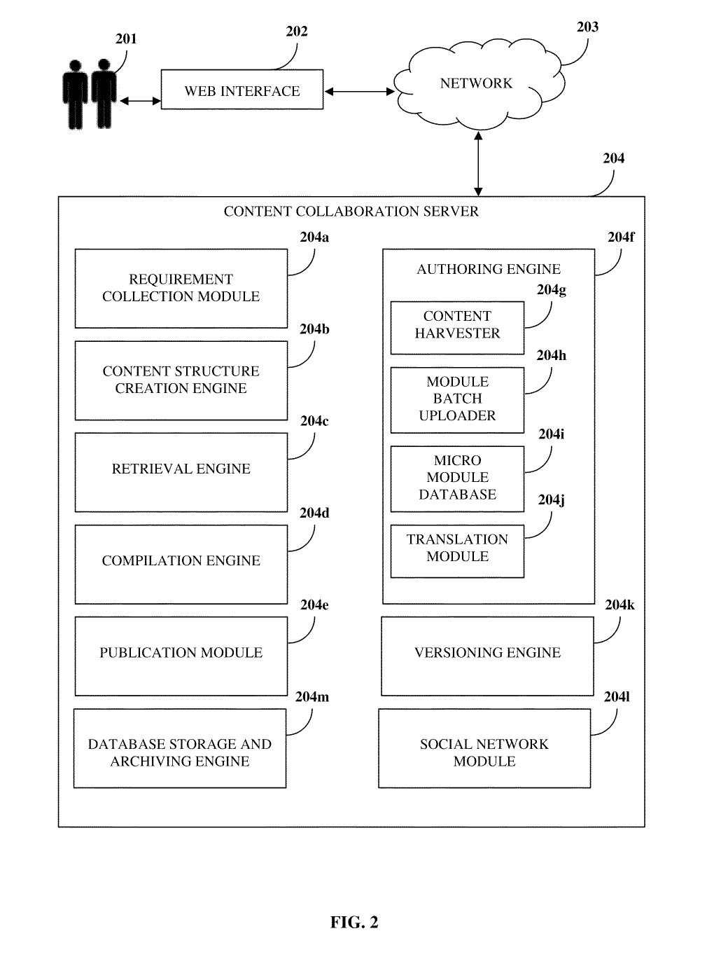

FIG. 2 illustrates a computer implemented system for compiling and publishing an online book in an online collaborative environment. The computer implemented system disclosed herein comprises a web interface 202 and a content collaboration server 204 connected via a network 203. Users 201 access the web interface 202 using a computing device. The computing device is, for example, a personal computer, a laptop, a mobile phone, a personal digital assistant, an electronic book reader, etc. In an embodiment, the users 201 register in the online collaborative environment to create and publish the online book via the web interface 202. The users 201 provide requirements and educational content in the online collaborative environment using the web interface 202. The users 201 also search for the educational content using the web interface 202.

The content collaboration server 204 comprises a requirement collection module 204a, a content structure creation engine 204b, a retrieval engine 204c, a compilation engine 204d, a publication module 204e, an authoring engine 204f, a versioning engine 204k, a database storage and archiving engine 204m, and a social network module 204l. The requirement collection module 204a collects requirements comprising, for example, educational subjects, topical subjects, information on syllabus, an outline, etc. from one or more users 201 in the online collaborative environment. The content structure creation engine 204b creates one or more content structures based on the collected requirements. The content structure creation engine 204b creates the content structures using, for example, search criteria, applicable context, curriculum guidelines, curriculum standards, degrees of difficulty, etc. The retrieval engine 204c retrieves the educational content from multiple online sources, created through authoring, or a combination thereof.

The authoring engine 204f enables the users 201 to author educational content for inclusion into the online book. The authoring engine 204f provides formatting instructions and structuring instructions in the online collaborative environment to the users 201 for the authoring. The users 201 author the educational content based on the formatting instructions and structuring instructions provided by the authoring engine 204f.

The authoring engine 204f comprises a content harvester 204g, a module batch uploader 204h, a micro module database 204i, and a translation module 204j. The content harvester 204g gathers the educational content from multiple federated repositories pre-declared by the users 201. The module batch uploader 204h performs batch uploads by uploading the educational content provided by the users 201 in the online collaborative environment. The uploaded educational content is transformed, reviewed, and represented as a content module. The content module is stored in the micro module database 204i.

The translation module 204j translates the stored educational content based on, for example, content, figure, legend, exercise, and answer. The authoring engine 204f also alerts authors who add non-printable MLOs. The versioning engine 204k maintains parallel versions and sequential versions of the retrieved educational content and the educational content authored by the users 201 in the online collaborative environment. Translation, transcription, and transformation of the educational content is performed automatically by the online collaborative environment, manually cleaned up by the users 201, and finally organized in a standardized format. The database storage and archiving engine 204m stores the educational content separately from metadata associated with the educational content.

The compilation engine 204d compiles the retrieved educational content into the content structures for creation of the online book. The compilation engine 204d compiles the retrieved educational content by automatic compilation or based on user declared specification. The publication module 204e publishes the online book in the online collaborative environment using pre specified templates or dynamically generated templates. The publication module 204e manifests the published online book in multiple formats. One of the formats is, for example, a printed paper book.

The social network module 204l enables creating, managing, and sharing of endorsements in a social network. The social network module 204l also enables user interaction related to content of the published online book. The social network module 204l also provides annotation tools for commenting on endorsements of the online book and a sharing utility.

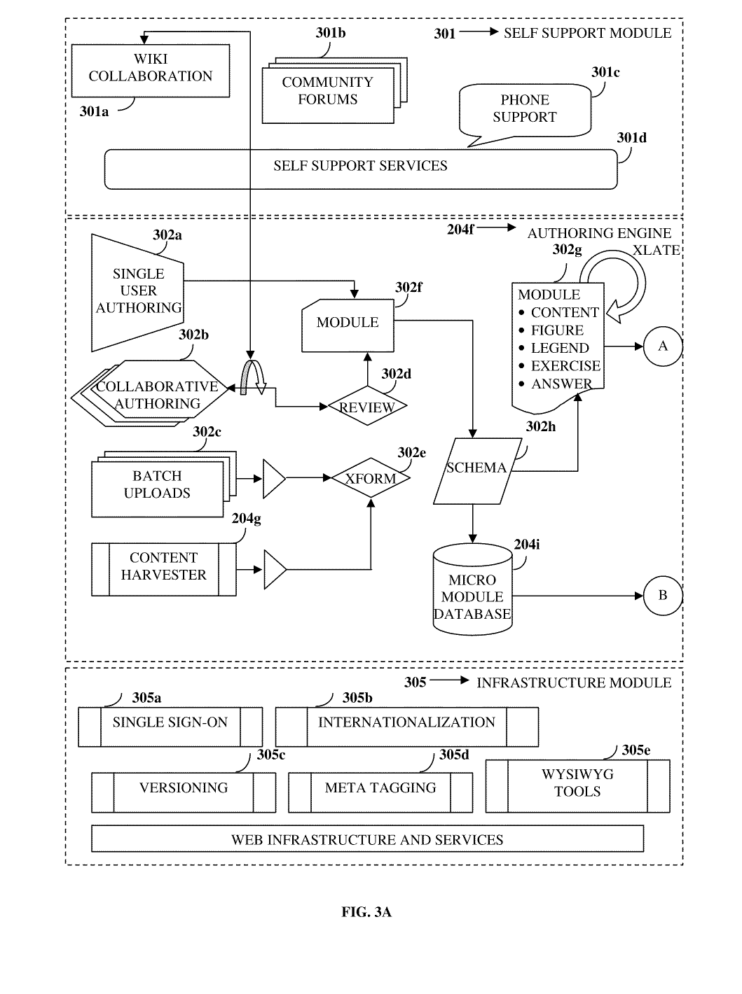

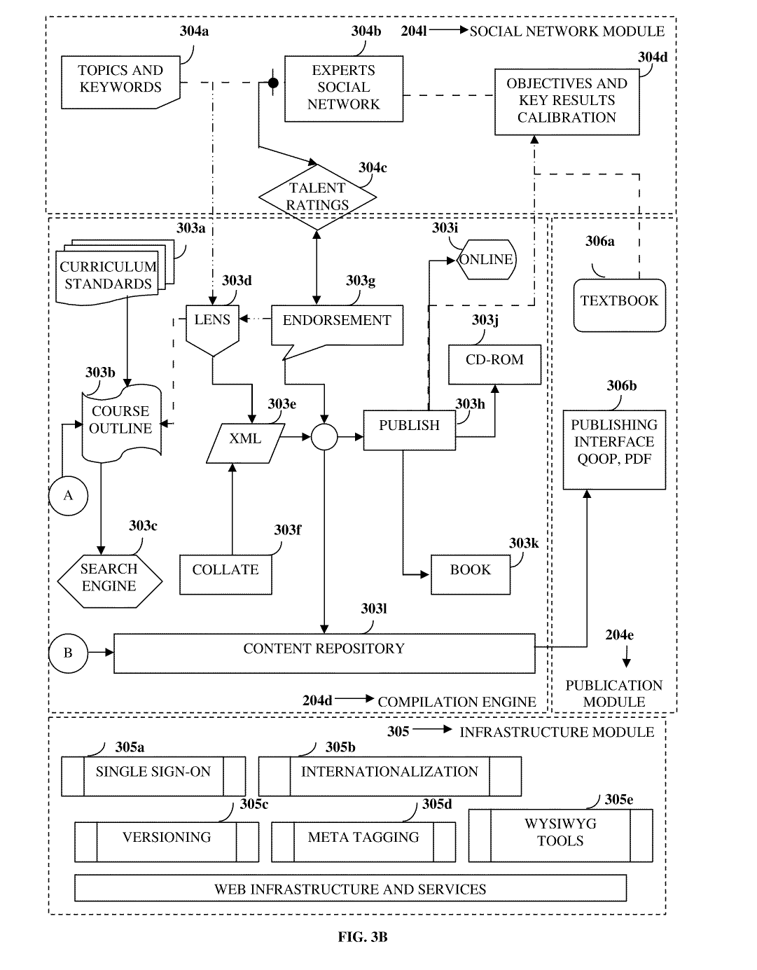

FIG. 3 exemplarily illustrates architecture of the online collaborative environment. The online collaborative environment incorporates a self support module 301, the social network module 204l, the authoring engine 204f, the compilation engine 204d, the publication module 204e, and an infrastructure module 305.

The self support module 301 administers user profiles and preferences at an individual level and a group delegation level. The self support module 301 further provides an administrative interface for logical and derived constructs, for example, roles and responsibilities. The self support module 301 enables metadata management and manages self support discussion forums, real time internet chat between users 201 in the online collaborative environment, etc. The self support module 301 allows the users 201 to electronically sign agreements and sends legal notices, licensing polices, and privacy notifications to the users 201. The self support module 301 enables self guided technical support using phone support 301c, community forums 301b, collaborative knowledge sharing mechanisms, and other self support services 301d.

The online collaborative environment incorporates the Wiki® collaboration module 301a for allowing collaborative authoring 302b, for example, by using online collaborative editing mechanisms, for example, in Wiki®, but targeted for content that is meant to be adapted and versioned.

The educational content can be authored and reviewed using the authoring engine 204f. The authoring engine 204f creates an outline for the online book, enables online editing and off-line editing of a new content module, uploads an existing content module document, handles batch uploads 302c, adapts the existing content module, translates the existing content module, modifies the existing content module, and associates tags and keywords. Both single authoring 302a and collaborative authoring 302b can be performed using the authoring engine 204f. The authoring engine 204f allows the users 201 to author educational content for inclusion into the online book, for example, by editing in Microsoft Word®. The educational content provided by single user authoring 302a is used to create a content module 302f as explained in the detailed description of FIG. 1. Furthermore, the educational content retrieved from collaborative authoring 302b, batch uploads 302c, and information gathered by the content harvester 204g are transformed 302e, reviewed 302d, and sent for creation of the content module 302f. The content module 302f is stored in a schema 302h of the micro module database 204i. The content module 302g from the schema 302h is then translated based on content, figure, legend, exercise, and answer. The educational content and the content module from the micro module database 204i are also stored in a content repository 303l in the compilation engine 204d.

The compilation engine 204d enables syllabus declaration, keyword based search, keyword generation, mapping of keywords, generating the table of contents, sequencing the table of contents and modules, adding content modules from other online books, picking templates, creating the online book, and archiving the definitions of the online book. The course outline 303b is generated in the compilation engine 204d from curriculum standards 303a and the translated module 302g. The compilation engine 204d obtains the curriculum standards 303a from curriculum repositories or through explicit recommendations from an experts social network 304b using the social network module 204l. The experts social network 304b provides topics and keywords 304a for the curriculum standards 303a. The curriculum standards 303a comprise, for example, syllabus, concepts, and skills required at different grade levels. A search engine 303c then performs a search based on the course outline 303b. The social network module 204l performs objectives and key results calibration 304d. The experts social network 304b also contributes to the performance of objectives and key results calibration 304d.

The social network module 204l further rates talents 304c of the users 201 who author the educational content. Based on the ratings, the educational content is endorsed 303g. The endorsements 303g are stored in the content repository 303l. Further, the social network module 204l creates, manages, and enables sharing of endorsements 303g. The social network module 204l further enables online book reviews, authored reviews, content module reviews, provides annotation tools for commenting on endorsements 303g. The social network module 204l further provides a sharing utility.

The compilation engine 204d collates 303f the educational content and converts the educational content into an extensible markup language (XML) format 303e using lens 303d. The educational content in the XML format 303e is stored in the content repository 303l of the compilation engine 204d. The educational content in XML format 303e with the endorsements 303g is then sent for publishing 303h to the publication module 204e which translates the educational content using the pre-defined templates or the dynamically generated templates. The published online book is, for example, obtained online 303i, on a compact disc (CD ROM) 303j, as the printed physical book 303k, on a universal serial bus (USB) drive, on the computing devices using really simple syndication (RSS) type feeds, audio books, etc. The publication module 204e publishes 303h the online book via a publishing interface 306b using the content repository 303l. The publishing interface 306b may use any on demand print market place service providers to physically print the online book. The online book may also be converted to a portable document format (PDF). The online book is, for example, published as a textbook 306a. The publication module 204e provides support for tools and interfaces to mask and filter the right set of content without compromising quality and richness of the content required.

The infrastructure module 305 provides the run time environment for executing application modules comprising language runtime environments, for example Java, Python, C, etc., and application services based on service oriented architecture using REST based APIs for loosely coupled federated application services. The infrastructure module 305 comprises the structure for compiling and publishing the online book. The infrastructure module 305 provides infrastructure services comprising single sign-on 305a for authentication and authorization, internationalization 305b for publishing the online book in different languages, versioning 305c for maintaining concurrent versions or adaptations of derived educational content, and meta-tagging 305d for associating descriptive information with the educational content. The infrastructure module 305 may further include WYSIWYG tools 305e for editing and collating operations. The WYSIWYG tools 305e are a word processing system that prints the text exactly as the text appears on the screen. The single sign-on provides access control that enables the users 201 to authenticate once and gain access to the resources of multiple software systems. The single sign-on enables the users 201 to register in the online collaborative environment. The internationalization enables the users 201 from all over the world to access and use the services provided by the online collaborative environment. Versioning maintains latest versions of the published educational content. Meta-tagging allows the search engine 303c of the online collaborative environment to accurately list websites based on the topics, keywords, and curriculum standards 303a inputted as requirements. The web infrastructure and services comprise the physical hardware, transmission media, and software used to interconnect computers and users 201 on the internet. The web infrastructure and services further comprises internet servers, web servers, internet storage, internet network equipment, and infrastructure software.

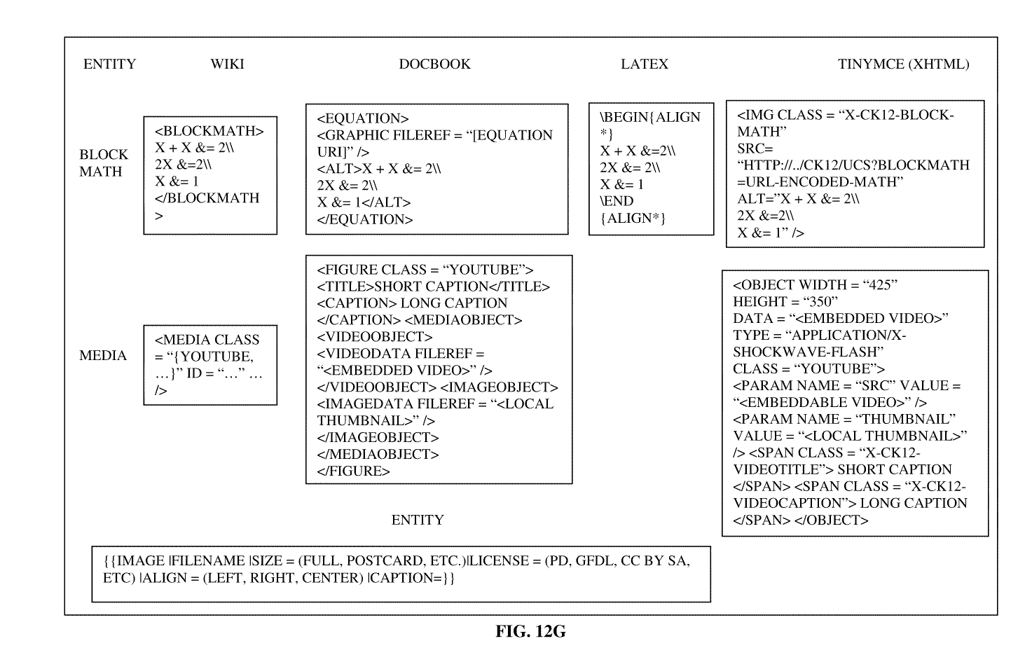

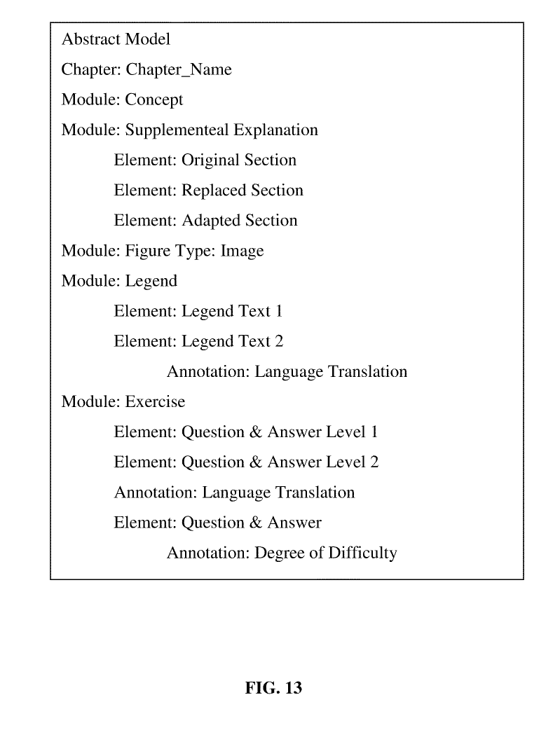

The architecture of the online collaborative authoring 302b is realized by using a composite of elemental structures herein referred to as “content structures” to electronically define the educational content of the online book, open authoring to provide collaborative services for creating the educational content, adaptive versioning, contextual collation, and flexible manifestation. The content structures are the basic building blocks of the online book that structure the retrieved educational content. The content structures are further explained in the detailed description of FIG. 13.

Open authoring is the authoring performed by any of the users 201 in the online collaborative environment. The online collaborative environment enables the users 201 to author the same educational content at the same time without interfering with each other's work. The online collaborative environment maintains the users' 201 different versions to enable roll back to previous versions or to converge the versions to create educational content. The users 201 may author the online book using the retrieved educational content and the educational content provided by the users 201. WYSIWYG tools 305e, implemented using latest technologies for example, asynchronous java script and extensible markup language (AJAX) herein referred to as “AJAX”, rich internet application (RIA), etc., are examples of tools that may be used for the open authoring. Authoring features for the open authoring are designed with behavioral perspectives and technical perspectives. The behavioral perspectives require a simple interface for example, rich text format (RTF), simple editor skins to make users 201 already acquainted with Microsoft Word® editing feel at ease. The interface supports both author centric views and content centric views. The interface enables flexible collation and template layouts for adapting to various delivery media for example, the compact disc, the USB drive, and the printed physical book 303k.

The technical perspectives require an interface that allows client side manipulation within an internet enabled platform, for example, AJAX. The technical perspectives comprise features that allow both private single user space versioning and open multi user commons collaborative versioning. The educational content needs to be updated and maintained. Updating the educational content requires content already available in a standard format, content yet to be developed in author centric mode and content centric mode, and content that may be retrieved automatically and housed in a content repository 303l by automated tool sets for retrieving educational content, and infrastructure to keep the educational content organized. The maintenance of the educational content includes activities comprising, for example, improving quality, iterating, revising, making factual changes, for example, the exclusion of the planet Pluto, and upgrading the educational content to keep up with the curriculum guidelines.

Adaptive versioning comprises versioning perspectives, for example, subject content versioning and versioning granularity. The subject content versioning are of two types, for example, main trunk versioning and branched versioning. In main trunk versioning, the latest or the head version of the educational content is considered. For example, Wikipedia® displays the latest version of an article entry for a topic. The users 201 may access a previous version if needed, but the educational content is always versioned on one trunk. The main trunk versioning is applicable to both single user authoring 302a and collaborative authoring 302b. In branched versioning, multiple parallel branches of the educational content are derived from one original source root. Branching may be based on content adaptations for example, specific school district adaptation, annotated translations, derivatives, teacher specific supplemental explanations based on a concept, etc. Branched versioning may introduce complexities during merging of the differences between the versions across the branches. The users 201 may utilize both the main trunk versioning and the branched versioning for adaptations.

Versioning granularity is the versioning in different granularity levels for the book adaptation. The different granularity levels are the elements, the content modules, collections, and the online book. The versioning of the elements result in multi lingual adaptations, exercises with varying degrees of difficulty, the online book with different supplemental explanations, the online book with different curriculum standards 303a, and the online book with sequentially evolvable content based on grade levels. The versioning of the content modules result in content modules with different element versions for compilation and publishing purposes, content modules on the same subject topic from different authors, and content modules translated to another language. The versioning of the collections result in supplemental byproducts, for example, teacher edition and preparation materials, associated lesson plans, and an online book with answer keys. The versioning of the online book result in endorsed versions, personalized version, shareable versions, and geography specific adaptations.

Adaptive versioning is of different types comprising, for example, semantic adaptations and syntactic adaptations. The semantic adaptations are open bounded and need to comply with an original version. The semantic adaptations are, for example, modifications to the educational content such as supplemental explanation and contextual content. The syntactic adaptations are derived from the original version based on specific criteria for adaptations. For example, the educational content translated into a different language and a new set of exercises with different degree of difficulty. Additional use case scenarios for adaptation versioning are: lowered or higher vocabulary levels for ease of reading, best practices on teaching prescribed concepts and lesson plans, etc.

Contextual collation is the process of collating the individual content modules into the online book. The contextual collation comprises explicit collation and implicit collation. The explicit collation is user driven and need not comply with any specific dependencies or business rules. The explicit collations may be guided by presenting related keywords, meta-tags, and curriculum guidelines. The implicit collation is system driven and complies with inbuilt dependencies, prerequisites, keyword taxonomies, and curriculum guidelines. For example, an author may prerequisite certain dependency modules to be included in the online book along with advanced subject topics.

The system driven contextual collation can be derived from different perspectives including vertical contexts, horizontal contexts, and peripheral contexts. The vertical contexts are based on the domain of a subject and underlying skill set requirements. For example, algebra II modules may require algebra I modules, and a concept module on spectrum may require a concept on light, properties of light, and refraction. The vertical contexts are prescribed and set by the curriculum guidelines. The horizontal contexts are based on related topics and grade level requirements for multiple subjects. Applied topics and problems are contextually related to the core concept. For example, the formula for calculating surface area of a cylinder may be contextually related to the area of a rectangle and area of a circle.

The peripheral contexts are driven by external or user behavioral factors. The collation of the online book with the content modules having easier exercises and generation of the online book with bilingual content modules for the same lessons are some examples for peripheral contexts. The mechanisms to derive contextual collation rules must be simple and evolvable. Use of existing platforms, for example, state standards and strand map documents for the contextual collation are preferred since basing the contextual collation rules on specific definitions and on the fly interpretation of rules may lead to complexities. Strand maps are graphical layouts of subject topics organized based on subject domain taxonomy and expressed as strands.

The flexible manifestation of the educational content compiled in the online collaborative environment is required to cater to the different needs of the users 201. Robustly bounded, well laid out, colorfully printed physical books is the primary format for the online books created in the online collaborative environment. It may also be possible to manifest the published online book in online formats and offline formats including optical discs and USB sticks. Manifestation formats may be modeled around a model view controller (MVC) design pattern. The MVC design pattern allows the content module to comprise the related data in a comprehensive manner while different views may be applied to project views meant for different form factors. For example, a written and stored online book on the online collaborative environment uses the flexible manifestation to deliver the online book as an audio book, digital versatile disc (DVD), CD ROM 303j, USB stick, online, and the printed physical book 303k.

In the online collaborative environment, the educational content, for example, a collection of printable and non printable content, textual content, and multimedia leaning objects, may be treated as a model. The different manifestations for example, print format, the online format, audio books, and USB format should be treated as views of the model. During the flexible manifestation, after collation, a set of post collation tasks are performed. For example, in a traditional textbook publishing environment the book is created in a top down fashion whereas in the book created in the online collaborative environment, the book is created in a bottom up fashion, i.e., the chapters are written followed by the compilation of the chapters for the subject. Therefore tasks, for example, pagination, creation of the table of contents, index, and glossary sections are performed after the collation is completed.

Content workbench tool (CWT) is the foundation of the authoring and editing content modules in the online collaborative environment. The CWT provides support for the users 201 to create, revise, adapt, layout, and publish the curriculum syllabus, course outline 303b, the elements of a chapter, the chapter, lesson plans, and the online book. The users 201 can undertake, assign, route, and manage tasks, for example copy editing, proof reading, domain requisite validation, calibrate readability levels, standards mapping, and curriculum association. The automated content processing tasks, for example, formatting translations, spell checking, grammar checking, etc., are supported by the CWT. Reporting and audit trails for revision histories, license compliance and inheritance, adoption rate, automated alerts and manual triggers for attribution approvals, and other future defined status transitions are also supported by the CWT.

The educational content can be processed through a linear editing cycle, as in traditional content management systems or in a cyclical editing cycle, as in Wiki® systems. The linear editing cycles will result in a system where there is a sequential workflow allowing the users 201 to route the task from one to another user 201. The cyclical editing cycle will result in a system that allows collaborative processing. The content is processed by adding content that is minimally required to be added to the content repository 303l, followed by vetting of the quality of the content for domain requisite and clarity, and endorsing suitability of the content for the right age group, and standards. The content authoring is performed in a closed way as in the content management systems, or in an open way as in Wiki®.

The CWT comprises user interaction controls namely dashboard control, editing control, and data control. The dashboard control is specific to the users 201 and is similar to an email inbox. The dashboard control is functionally responsible for task routing and inbox management. The dashboard control provides a list based view and a detailed entity view of the entities to be processed in the system. The entities comprise, for example, the syllabus, the course outline 303b, the elements, the chapter, the lesson plan, and the book format. The editing control is attached to all the entities and allows operations contextually possible with the entities. For example, the editing control may present different operational commands to edit the course outline 303b from the commands used to edit the chapters. The editing control may seek approval of the changes made to the entities. The data control allows the users 201 to assign tags, define, and associate the metadata, correlate content to subject domain requisites, curriculum standards 303a, etc. The data control is simple to use and is based on operating system metaphors for example, menus, drag and drop, command keys, etc.

FIG. 4 exemplarily illustrates the lifecycle of compiling the educational content into the online book. The users 201 register in the online collaborative environment. The users 201 input requirements and utilize a browser to browse 402 through the retrieved educational content. The retrieved educational content is assembled after browsing. An editor edits 401 the retrieved educational content if any adaptations are needed. The editor comprises tools and structures related to creating, authoring, and reviewing the retrieved educational content. The browsed, edited, and assembled educational content is adaptable 405 if new derivatives are required. For example, one could get a book that meets California standards, and derive the book to meet New York standards by adapting that book for New York standards. A compiler compiles the browsed, edited, and assembled educational content which is further sent to an endorser for endorsement 403. The compiler implemented by the compilation engine 204d comprises the tools and structures related to searching, browsing, and perusing the retrieved educational content for collation. The publisher publishes 404 the online book in the online collaborative environment. The published online book may be manifested in, for example, a compact disk and a textbook. The publisher implemented by the publication module 204e comprises the tools and structures for publishing the online book.

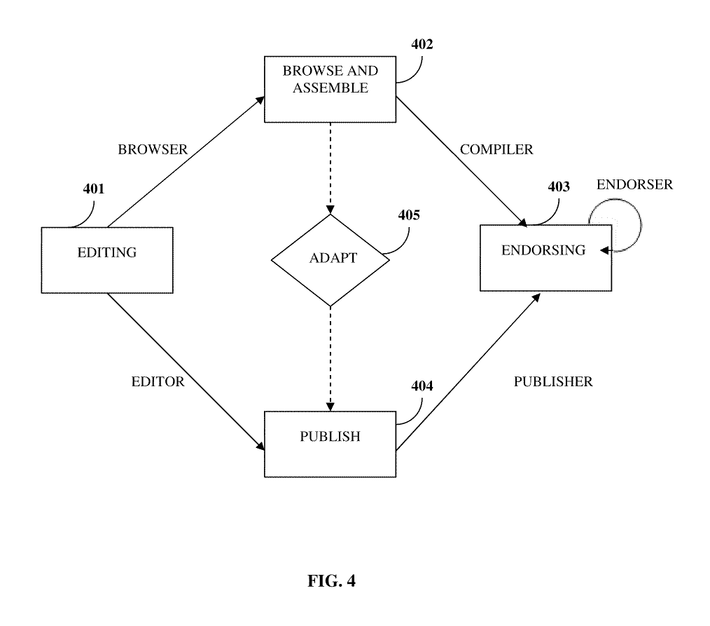

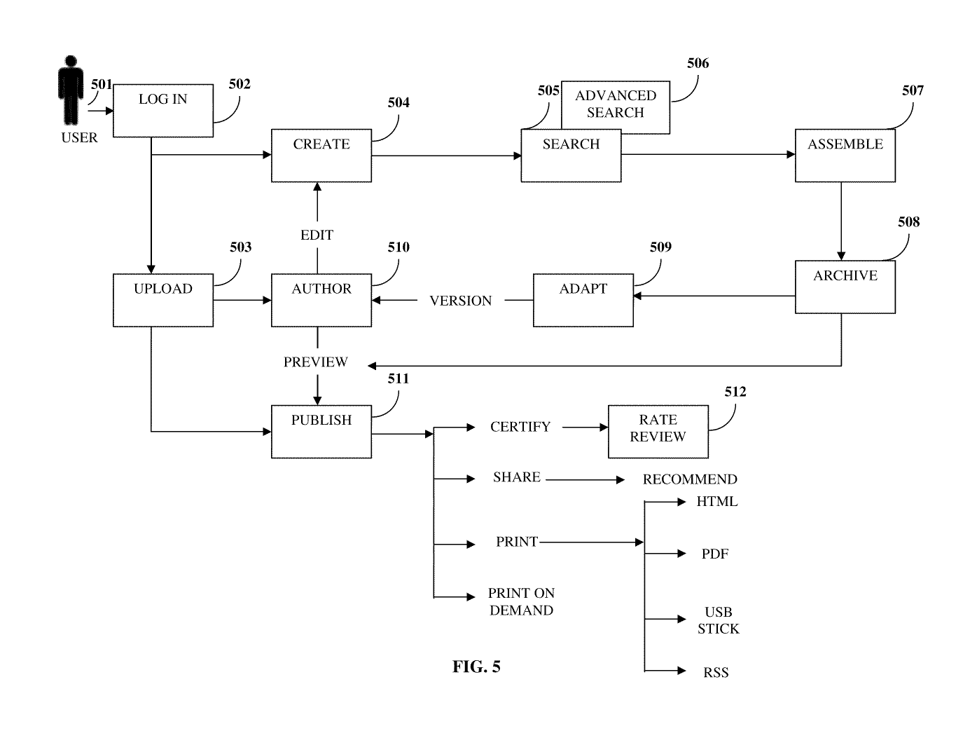

FIG. 5 exemplarily illustrates a flowchart for compiling and publishing the online book in the online collaborative environment. Consider an example where a user 501, for example, Thomas, a registered user, logs 502 into the online collaborative environment. Thomas can create 504 an online book and also upload 503 educational content for authoring in the online collaborative environment. For creating the online book, Thomas conducts a search 505 by inputting search criteria, for example, topics, keywords, curriculum standards, etc. representing Thomas' requirements. Thomas conducts an advanced search 506 by inputting more search criteria representing requirements. The educational content is retrieved, assembled 507 and archived 508 for future reference by the users 201. The educational content is adapted 509 and versioned accordingly. The versioned educational content is then used for authoring 510 by editors and registered users 201 in the online collaborative environment. The educational content uploaded 503 by Thomas is also authored 510 and previewed. The assembled online book is published 511. The published online book may be certified by the users 201 by ratings and reviews 512. Thomas may share the published online book and recommend the online book to other registered users 201. Thomas may also print the book on demand. The book may be printed and displayed in, for example, a hypertext markup language (HTML) format, a PDF format, USB stick, RSS type feeds, audio books, etc.

Consider an example where a teacher enters the online collaborative environment to search for difficult homework and easy homework based on the students being fast learners and slow learners respectively. For example, the teacher may search for a cubic polynomial equation topic in the online collaborative environment to create an online book for fast learners and slow learners. The online collaborative environment adjusts to different levels and requirements given by the teacher. The created online book will comprise a chapter on cubic polynomial equation and will comprise two different sets of homework problems, one each for the fast learners and the slow learners, for example, x\hat{0}3−729=0 versus x\hat{0}3−8=0.

In another example, a parent may have to search for additional educational content other than the typical textbook for children. The online collaborative environment narrows down searches to yield relevant educational content for the parent. For example, the parent may search for laws of properties of light for a 7^{th} grade child in particular and the online collaborative environment yields exact search results based on the given requirements. The online collaborative environment allows the parent to define search criteria including grade level to enable the online collaborative environment to redirect and search accordingly. For example, the parent may search for simultaneous equations for a 7^{th} grade student which employ substitution method for solving a problem or search for simultaneous equations for a 9^{th} grade student which employ matrices for solving the problem.

A student may search for additional information other than the textbook prescribed. The online collaborative environment comprises educational content and online books that are vetted and endorsed, from which the student can acquire additional information. For example, if the student wants to create an online book on penguins, the student can incorporate existing educational content or adapt educational content on the online collaborative environment. The student can create a project from the online book. The online book may be shared with lower grade students for the slow learners since the online book is expressed from another student's viewpoint.

The school system administrators may enter the online collaborative environment and verify alignment of the online books and the educational content within the realm of particular syllabus and curriculum guidelines. If alignment exists, the school system administrators may lock in the particular educational content, i.e., the educational content is time stamped, sealed, and endorsed for further incorporation without additional adaptation. If any additional adaptation needs to be performed in the online book, the original sealed and endorsed educational content is kept intact whereas the additional adaptation is time stamped differently. The school system administrators can thereby roll back if the changes are not approved and restore the locked educational content while other users 201 are creating new versions of the online book.

The authors may start a new chapter, a new syllabus, a new course outline and allow changes and contributions to be made collaboratively by the other users 201. The reviewers may review the educational content by proof reading, spell checking, grammar checking, checking for suitability, readability, and correctness of the educational content, etc. The endorsers perform endorsing of the educational content after the review of the educational content for further publishing as the online book.

The online collaborative environment is designed to identify related chapters as dependents, the dependencies, advanced topics, and detailed topics for the given requirements. The dependents and the dependencies must be in sequence and is automatically driven by the online collaborative environment. The online collaborative environment is designed to associate grade levels, state standards, national standards, specifications from associations, and charter school syllabi to a specific chapter or a key topic. The online collaborative environment may also be designed to tag pedagogical keywords, for example, know, understand, learn, practice, experiment, develop, and quiz to cluster the educational content based on desired outcomes. The online collaborative environment may be designed with mechanisms to rate, review, and recommend chapters based on pre-defined qualifiers, for example, popular, helpful, and endorsed. The online collaborative environment thus designed will yield results based on search conditions and contextual application of user profiles.

FIG. 6 exemplarily illustrates functional modules of open authoring and collaborative authoring in the online collaborative environment. The online collaborative environment allows the users 201 to leverage the services or subsystems in an independent basis unlike, for example, Wiki® engines, for example, MediaWiki®, MoinMoin®, etc., which are based on monolithic architectures and do not easily allow the users 201 to leverage the services or subsystems in an independent basis. For example, it is difficult to replace MediaWiki's® MySQL® based storage engine with a distributed version control system, for example, Bazaar. The online collaborative environment is composed of four major subsystems comprising the authoring engine 204f, a rendering engine 604, the versioning engine 204k, and the database storage and archiving engine 204m. Each of the engines 204f, 604, 204k, and 204m expose interfaces for services, independent of implementation, as independent sub-systems such that one can mash-up their own services with the system provided services. For example, an electronic mail client can be used as a rendering device within the rendering engine 604 as a plug in while leveraging the archival and versioning services from the backend.

The online collaborative environment may enable plug in interfaces to integrate external authoring tools such as electronic mail client, WebTops such as GoogleDocs®, and syntax checkers such as spelling and grammar. The plug in interfaces translate, reformat, and archive internal storage formats and schemas as needed for domain specific usages, for example, encyclopedia as in Wikipedia®. The plug in interfaces may generate alternative rendering formats as needed by the application, for example, the PDF or the RSS type feeds. The online collaborative environment may provide support for branched versioning capabilities since main trunk versioning is typically useful in encyclopedia or dictionary type applications whereas the branched trunk versioning is useful in applications such as the online book.

The authoring engine 204f utilizes a WYSIWYG editor, for example, the WikiWYG editor 601 compatible with MediaWiki® syntax specifications. The WYSIWYG editor has bidirectional compatibility between Wiki® syntax format and internal storage format. The WYSIWYG editor of the authoring engine 204f comprises pluggable skins to generate domain specific constructs. For example, different WYSIWYG constructs are required to create the syllabus, book outline, and chapters, upload images, and map subject contents to the curriculum standards in the online collaborative environment. The WYSIWYG editor implements a syntax generator engine as an extensible and template skin that maps to a subset of WYSIWYG syntax supported by the online collaborative environment. The authoring engine 204f integrates support for spelling and grammar checks by utilizing a built in spelling and grammar checking tool and a collection of APIs to plug in external spell and grammar testers. The authoring engine 204f differentiates between private and public namespaces that enable both open and closed authoring environments.

The authoring engine 204f tracks and merges changes in an intuitive and simple manner, add annotations, comments, and threaded discussions to the educational content. The authoring engine 204f comprises APIs for tapping into content lifecycle stages for delivering notifications and status updates through external task and inbox management tools. The authoring engine 204f allows online authoring and offline authoring, requires automated translation and content extraction mash up APIs for WebTops, for example, GoogleDocs®. The authoring engine 204f also comprises APIs to post educational content from alternate authoring tools, for example, Microsoft Word® or electronic mail clients 607 through simple mail transfer protocol (SMTP) and REST protocols 610.

The versioning engine 204k performs inbound versioning operations 602 comprising creating a leaf node, posting the latest revision of the node, creating a parallel collaboration branch, acquiring version history, rollback to a specific version, and previewing a specific version in a user specified rendering format. The versioning engine 204k allows merges across branches. The versioning engine 204k performs outbound versioning operations 603 comprising acquiring a latest version (head) and specific version of the node, previewing the specific version in the user specified rendering format, and viewing version differences as part of integrated authoring tool controls. The versioning engine 204k comprises APIs to acquire version history and statistics, views annotations and comments as an overlay, and views laid out educational content processed through templates of extensible stylesheet language formatting objects (XSL FO).

The database storage and archiving engine 204m stores the educational content separately from metadata by storing the educational content in a distributed versioning system and providing database based storage for the metadata, references, and parsed indices. The database storage and archiving engine 204m provides support for browsing and searching of the nodes, viewing internally stored objects, for example, images, and externally referred objects, through uniform resource locators. The database storage and archiving engine 204m performs corresponding database operations, for example, create, read, update and delete on each of the nodes.

The database storage and archiving engine 204m requires a database schema to provide support for storing, indexing, and retrieving application domain specific versioned nodes. The nodes are the chapters, the elements, resources, annotations, endorsements, tags, keywords, syllabus, outlines, the online book, etc. The database storage and archiving engine 204m enables periodical archival and backups in automated and on demand basis. The database storage and archiving engine 204m stores, manages, and version taxonomies, ontology, categories, and domain specific hierarchies in the micro module database 204i. The database storage and archiving engine 204m allows online and offline usage, mirror and auto synchronization between mirrored repositories, and provide APIs to traverse storage schemas and acquire associated metadata of the storage schemas to generate statistics in an automated manner. The content is stored in a file system storage 611.

The rendering engine 604 handles HTML rendered layouts and views, automated printer friendly views, inbuilt alternate formatting support and generation of the PDF and the RSS type feeds 606. The rendering engine 604 comprises plug in interfaces for XSL FO 605 template engine to generate user defined views through XSL scripting and REST and SMTP APIs to push the formatted and rendered contents to clients, for example, the electronic mail client and WebTop clients, for example, the GoogleDocs®. The rendering engine 604 communicates with Word processors 608, docbook processors 609, and the email clients 607. The rendering engine 604 further communicates with the WYSIWYG editor.

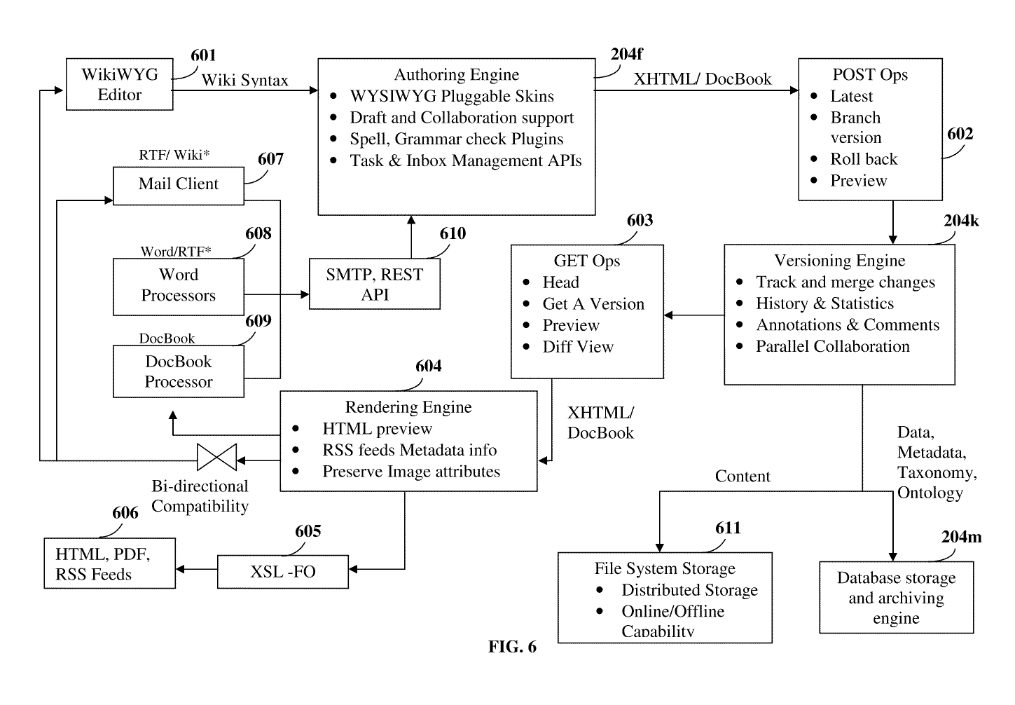

FIG. 7 exemplarily illustrates a schematic flow of a computer implemented method of compiling and publishing an online book in an online collaborative environment. A user 201 enters 701 a portal application or home page of the online collaborative environment. The user 201 optionally logs in 702 to the online collaborative environment. The user 201, for example, browses 708 through the online collaborative environment. The user 201 performs a parametric 710 or a contextual 711 search 709 for one or more educational subjects, topical subjects, information on syllabus, an outline, etc. One or more content structures are created based on the searched criteria. Educational content is retrieved and the results are listed 712 to the user 201. The listed results can be viewed 713, printed 714, and shared 715 in the online collaborative environment by the user 201. The user 201 can bookmark 716 the listed results for quick access at a later time, send 717 the results to a printer to print, or can subscribe 718 to view new information on topics searched for by the user 201.

The listed results are compiled 721 through either automatic compilation or by user 201 declared specifications. The user 201 can also create 703 content for a chapter 720 to be included in the online book 719. The content authored 723 by the user 201 for the chapter 720 in the online book 719 is compiled 721 into the content structures along with the retrieved educational content by the compilation engine 204d. The compiled content is then edited 724 and re-sequenced 722 according to user 201 preferences. Any relevant metadata is added 725 and associated 726 with the content structures. The compiled content is then saved 727 for review.

The chapter 721 in the online book 720 in the content structures is reviewed 704 by one or more users 201. The users 201 endorse 728 or annotate 729 the content and allow sharing by other users 201 depending on preferences of the user 201. The users 201 can declare the content as personal or public 730. The reviewed content is then rated 731 by one or more users 201 and the content is discussed 732, approved, and recommended 733 to other users 201. The users 201 discussing the content may suggest and add other metadata relevant to the content in the content structure. The content with the newly added metadata is reviewed again. The process continues until all the content in the content structure is approved, discussed, and verified. The content is then moderated 705 by checking for domain correctness 734, curriculum standards 735, readability levels 736, etc. of the reviewed content. After the content is moderated, the content is administered depending on the pedagogical outcomes 737 of the moderated content. The content is then sent for approval and publication. If the content is rejected 738, the content is blocked 739 and does not get published. Rejected content is usually deleted 746. If the content is approved 740, the content is published 741 and shared in the online collaborative environment. The published online content is in the form of an online book.

The artifacts 742 of the online book are administered 706 by creating 743 indexes 744 and allowing users 201 access to the online book. The content of the online book may be imported and exported 745, may be deleted 746, may be certified 747, or locked 748. The certified online book is then available for use and the content of the book is searchable as part of the educational content. The user 201 can log out 707 of the online collaborative environment at any instant.

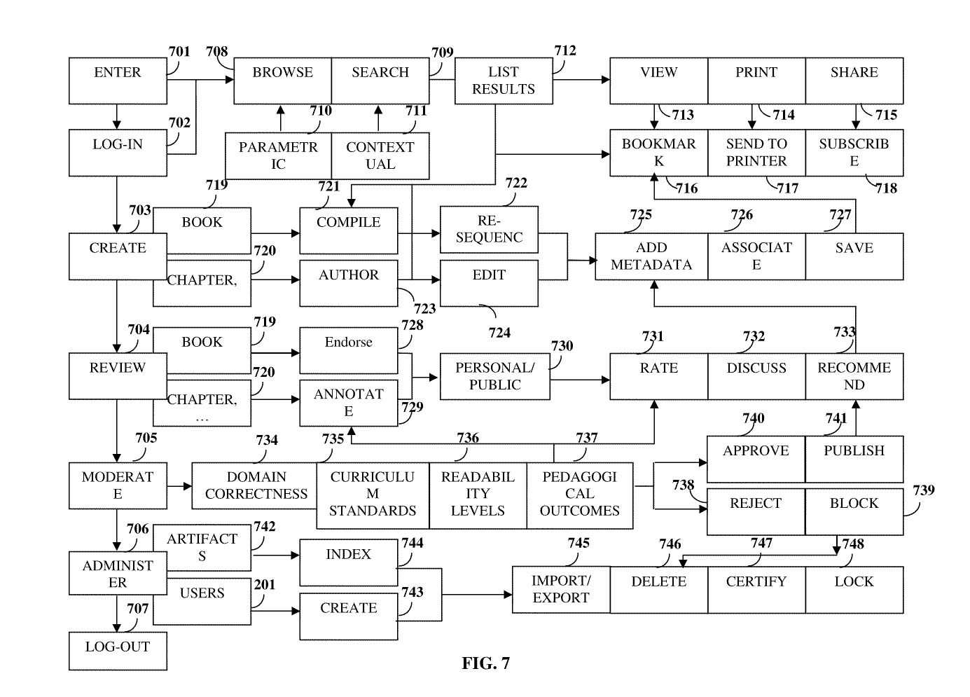

FIG. 8 exemplarily illustrates the architecture of a computer system 800 employed in the content collaboration server 204. The computer system 800 comprises a processor 801, a memory unit 802 for storing programs and data, an input/output (I/O) controller 803, and a display unit 806 communicating via a data bus 805. The memory unit 802 comprises a random access memory (RAM) and a read only memory (ROM). The computer system 800 comprises one or more input devices 807, for example, a keyboard 811 such as an alphanumeric keyboard, a mouse 813, a joystick 812, etc. The I/O controller 803 controls the input and output actions performed by the users 201. The computer system 800 communicates with other computer systems through an interface 804, comprising, for example, Bluetooth interface, infrared interface (IR interface), WiFi interface, universal serial bus interface (USB), local area network or wide area network (LAN or WAN) interface etc.

The computer system 800 further comprises a fixed media drive 808 and a removable media drive 809 for receiving removable media. The computer system 800 further comprises output devices, for example, a printer 810 for receiving and reading digital data on a compact disk, a digital video disk or other medium. Computer applications or programs are used for operating the computer system 800. The programs are loaded onto the fixed media drive 808 and into the memory unit 802 of the computer system 800 via the removable media drive 809. Applications are executed by double clicking a related icon displayed on the display unit 806 using the mouse 813 or through other input devices 807.

The computer system 800 employs an operating system or performing multiple tasks. The operating system further manages security of the computer system 800, peripheral devices connected to the computer system 800, and network connections. The operating system employed on the computer system 800 recognizes keyboard inputs of a users 201, output display, files and directories stored locally on the fixed media drive 808, for example, a hard drive. Different programs, for example, a web browser, e-mail application, etc., initiated by the users 201 are executed by the operating system with the help of the processor 801, for example, a central processing unit (CPU). The operating system monitors the use of the processor 801.

The locations of the instructions in the modules of the content collaboration server 204 are determined by a program counter (PC). Instructions for coordinating working of the modules of the content collaboration server 204 are retrieved by the CPU from the program memory in the form of signals. The instructions fetched by the CPU from the program memory are decoded after being processed. The instructions are placed in an instruction register (IR) in the CPU. After processing and decoding, the CPU executes the instructions.

The CPU comprises an arithmetic and logic unit for performing mathematical and logical operations on the instructions. The instructions comprise, for example, creating the content structure based on the collected requirements, retrieving and compiling the educational content in the content structures, etc. The output of the processor 801 comprising the created online book is displayed on the display unit 806 of the computer system 800 of the content collaboration server 204. The users 201 interact with the computer system 800 of the content collaboration server 204 using the web interface 202.

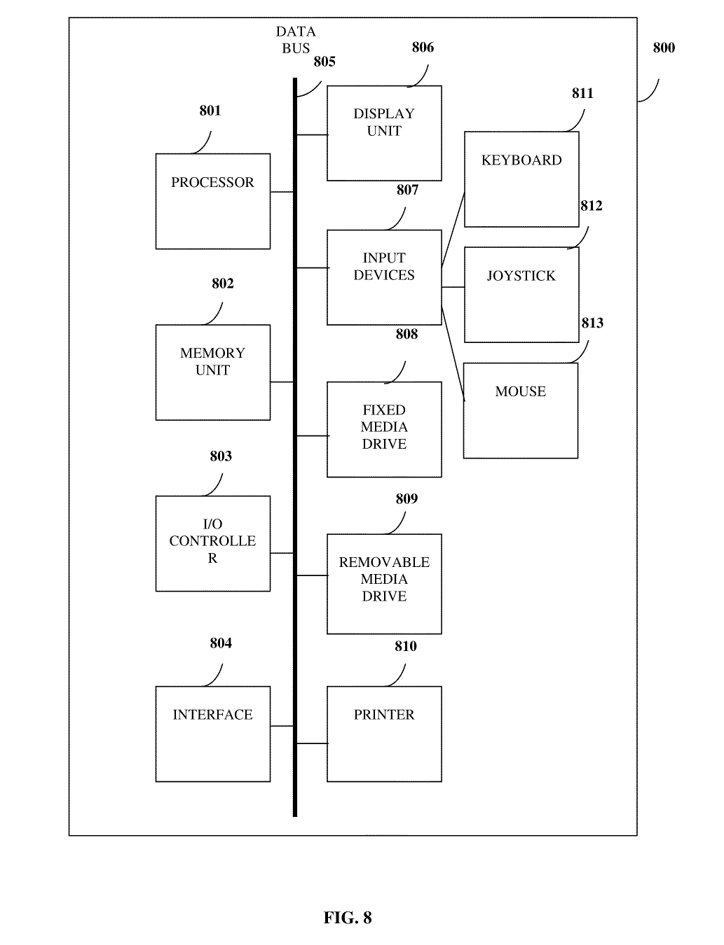

FIG. 9 exemplarily illustrates a content page of an online book created using the online collaborative environment. The content page describes two topics, namely classical mechanics and Goldberg variations. The explanation of the topics in text are shown in the content page along with video content further explaining and supplementing the text content of the content page. The number of star signs illustrated on the illustration of the second video content represents the ratings from the users 201 in the online collaborative environment. Five stars represent the most highly rated and relevant content.

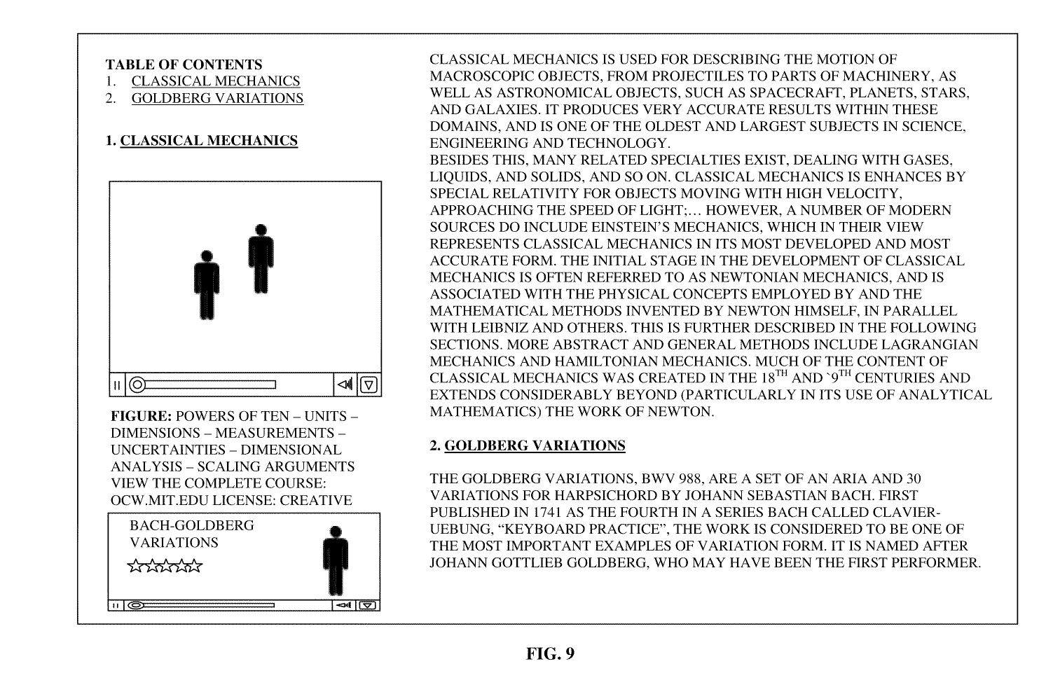

FIG. 10 exemplarily illustrates a content page of a published printed book created in the online collaborative environment. The content of the published printed book cannot contain video content for supplementing the information provided by the text content. However, photographs and other images can be used to supplement or further explain the content provided in the text.

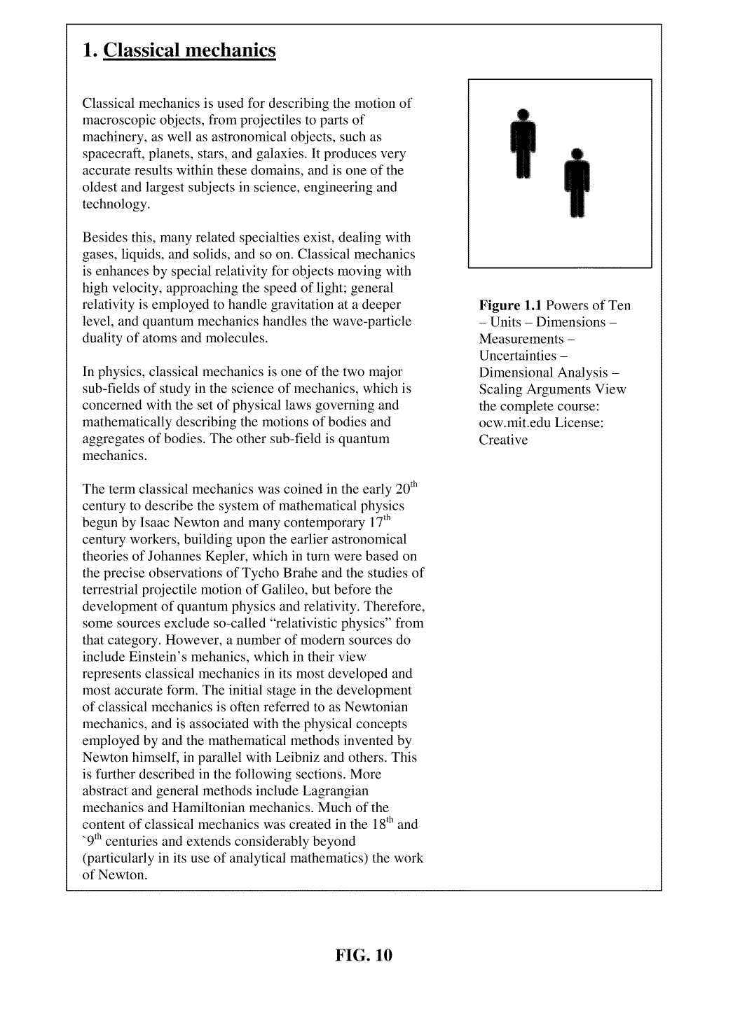

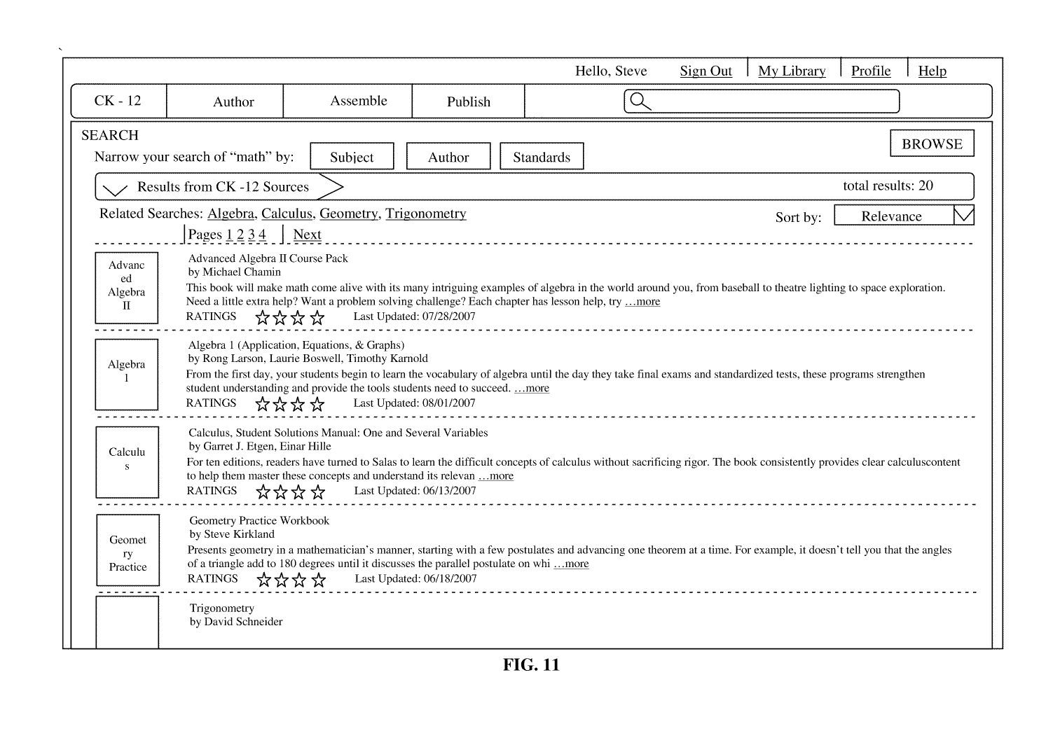

FIG. 11 exemplarily illustrates a webpage comprising educational content retrieved using the online collaborative environment. Listed results for a search related to a keyword “math” performed on the online collaborative environment are exemplarily illustrated on the page. The online collaborative environment searches educational content using the keyword “math” and the retrieved educational content is listed as search results. Each of the listed retrieved educational content comprises information, for example, name of the author, title of the publication, user rating of the publication, comments relating to the publication, etc. about the corresponding retrieved educational content. The user ratings of each of the listed results are also illustrated beside each entry of the retrieved educational content. The online collaborative environment provides the user with suggestions regarding narrowing down of the subject field used as the search keyword. As exemplarily illustrated in the example in FIG. 11, the online collaborative environment suggests the use of keywords, for example, “Algebra”, “Calculus”, “Geometry”, and “Trigonometry” to narrow down the searched results. The retrieved educational content can be sorted by, for example, relevance to the searched keyword, rating of the retrieved educational content, etc. The users 201 in the online collaborative environment may use the listed content for authoring, assembling, and publishing the online book.

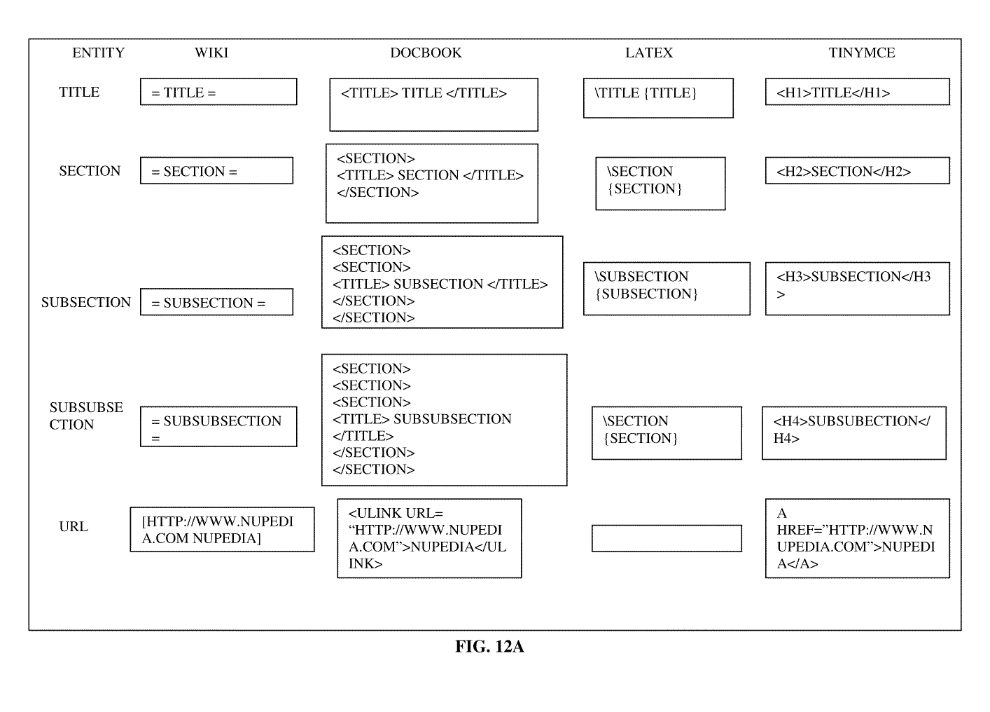

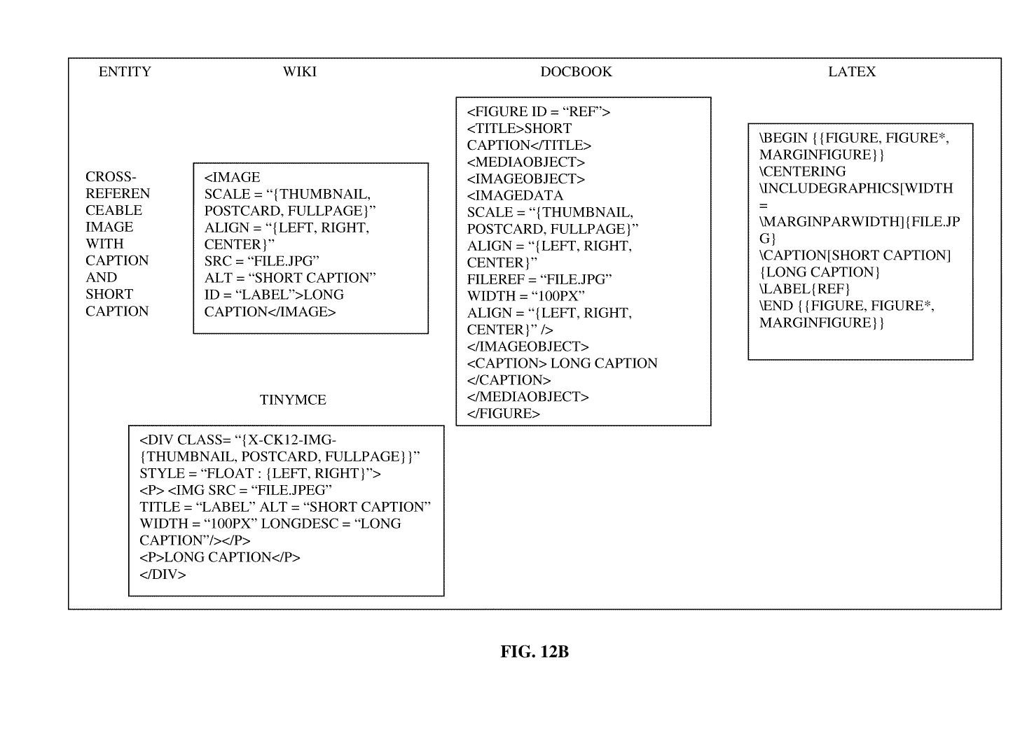

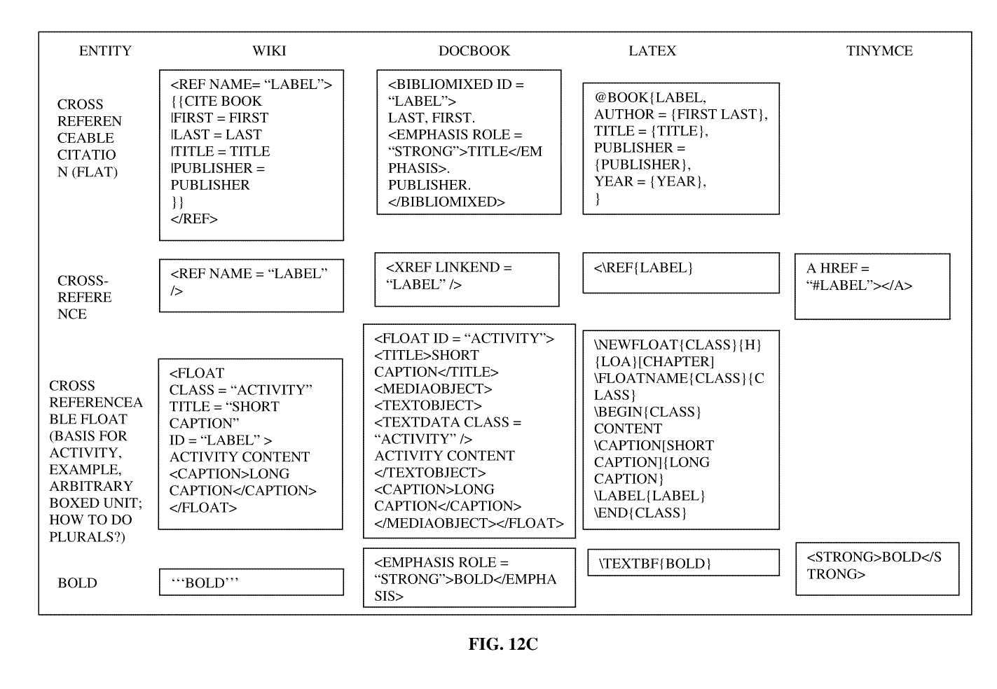

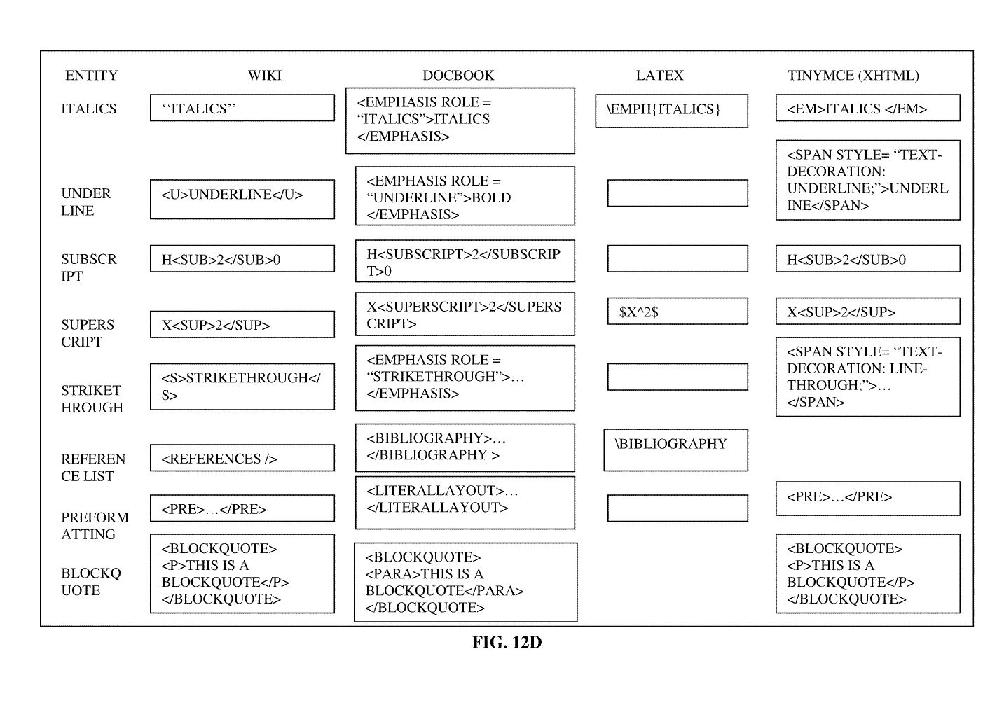

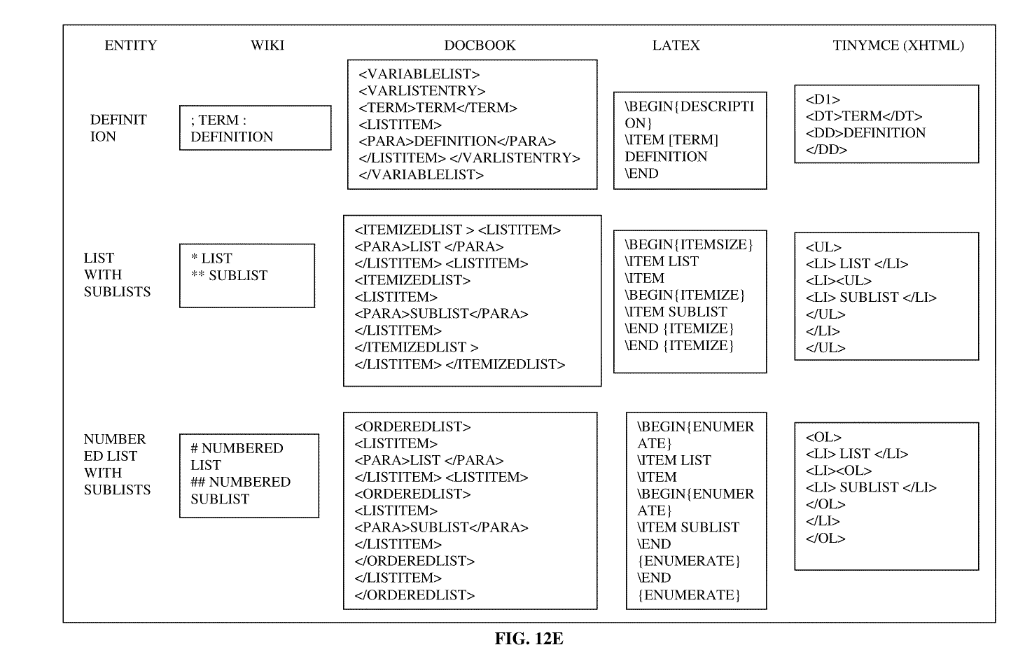

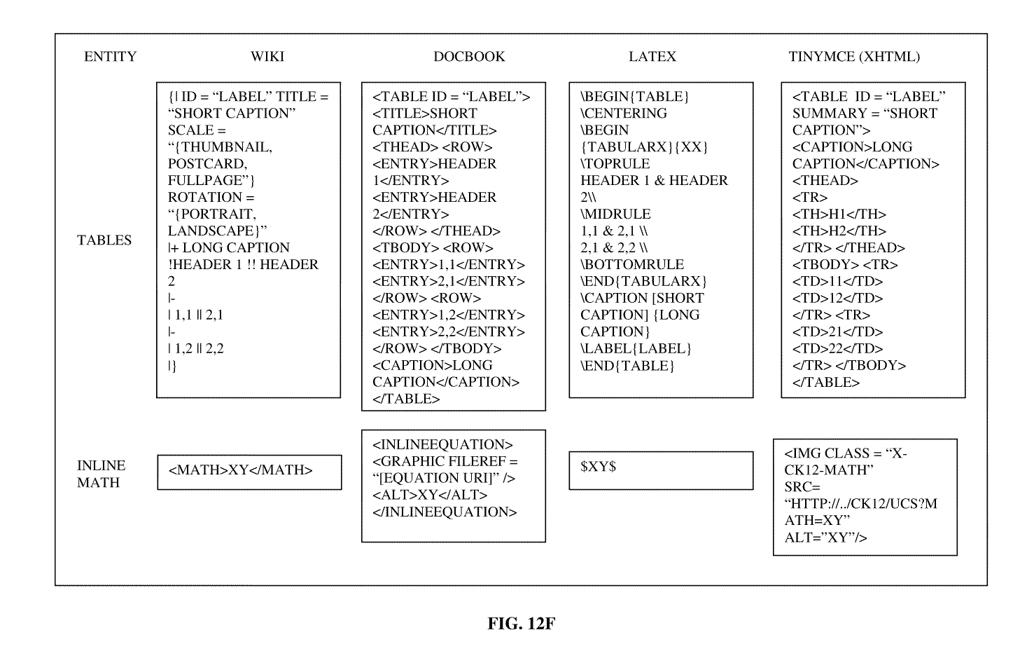

FIGS. 12A-12G exemplarily illustrate a reduced set of instruction code used for authoring content on the online collaborative environment. The reduced set of instruction code used by the users 201 of the online collaborative environment enables manifestation of the authored content and translation of the authored content to various formats. FIGS. 12A-12G exemplarily illustrate the instruction code provided for authoring content on the online collaborative environment using multiple tools, for example, wiki, docbook, latex, and Tiny Moxiecode Content Editor (TinyMCE). For the “Title” entity, the instruction code can be represented in extended Hyper Text Markup Language (XHTML). For the “Section” entity, the “Subsection” entity, and the “Subsubsection” entity, the instruction code representation in XHTML uses a header tag 1 level lower than the “Section” entity's level. For the entity “Cross referenceable image with caption and short caption”, the alignment and width attributes are optional. The long caption is duplicated in the HTML version so that the long caption is rendered and long caption is easily accessible by an editor when transforming back to docbook.

The online collaborative environment enables decomposition of a book into content structures, representation of the content structures in a computer parsable format, and re-composition of the content structures into a holistic book that can be delivered online or as printed material. Each of the content structures comprises content modules and elements. A sample code used to define a content structure comprising content modules and elements is exemplarily illustrated in FIG. 13. For the compiled educational content to be meaningful and complete, a content structure may, for example, be a coarse grained structure and a fine grained structure as explained in the detailed description of FIG. 3. The coarse grained structure provides a rigid system while a fine grained structure may lead to fragmentation and management complexities. In addition, the granularity of the content structure also depends on the context of that structure. For example, a typical textbook chapter comprising concept, supplemental explanation, figure, legend, exercises with question and answer sections is minimally partitioned as illustrated in FIG. 13. FIG. 13 illustrates usage of content modules, elements, and annotations. While a more detailed and finer level of granularity for sections such as concept, figure, question and answer is not needed, sections such as supplemental explanation, legend, and exercises could be more granular in order to adapt for user level annotations, language translations, and exercises with varying levels of difficulty respectively.

The content modules describe the lowest granular form of content structures that are used during the compilation and manifestation lifecycle stages of book creation. Based on the requirements for adaptations and evolutions, the content modules may be fine grained into elements which can either be reused as they are or be adapted for user specific needs. An element can be annotated based on the adaptation or evolution of the educational content. Hence, a content module can either be a holistic content module or a combination of elements with annotations attached with each of the element adaptations if needed.

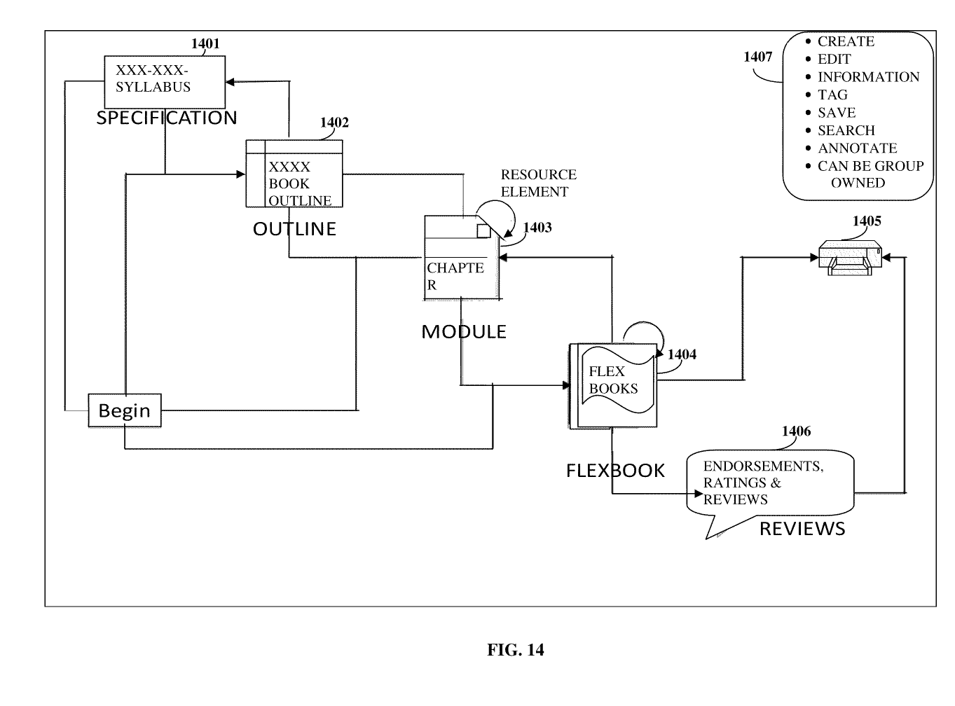

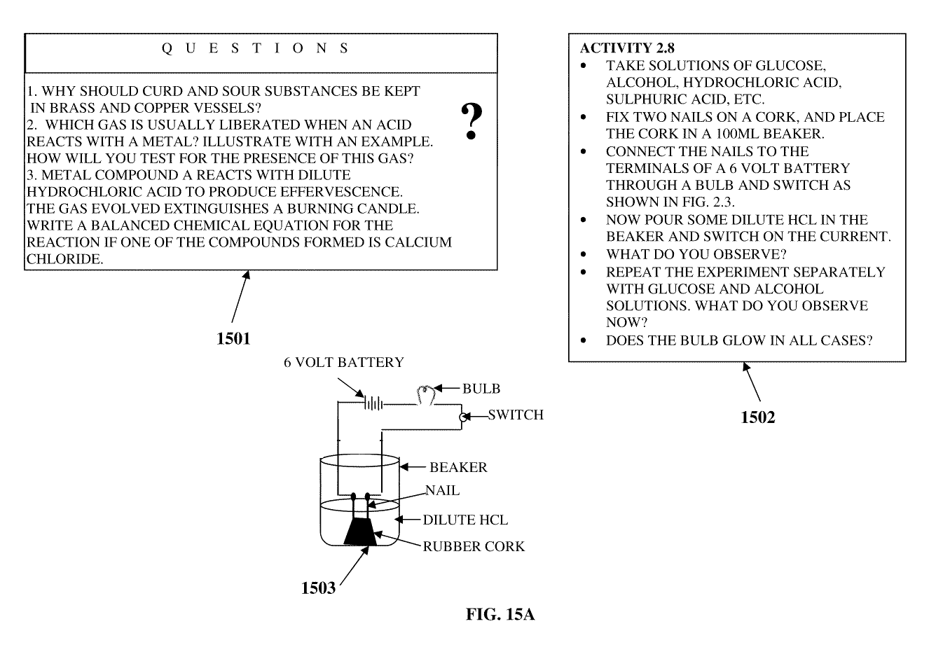

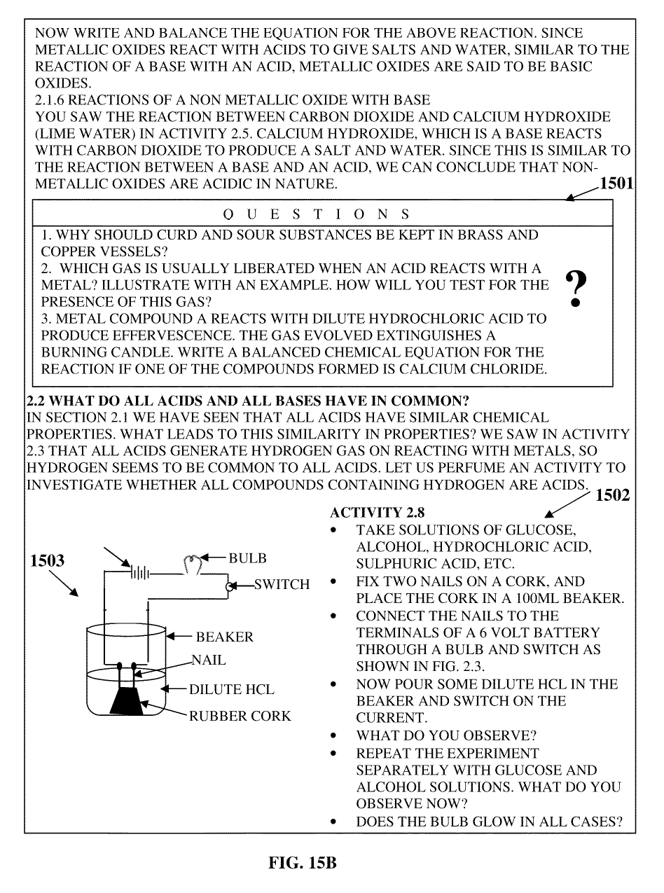

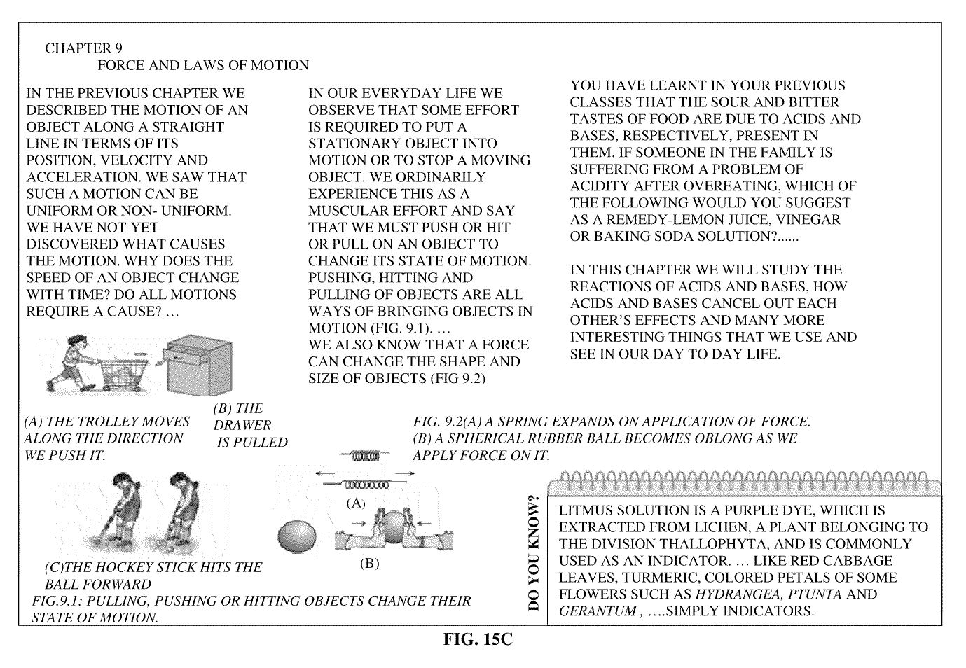

FIG. 14 exemplarily illustrates the process involved in creating an online book by aggregating one or more content structures. The user specifies 1401 a set of conditions, for example, search criteria. An outline 1402 mapped to curriculum standards is generated for the required specification. Based on the outline, resources, for example, images 1503 of element type: Image and media objects are combined with text of element type: Question and Answer Section 1501 and element type: Activity Box 1502 as exemplarily illustrated in FIG. 15A and presented in a contained format to create one or more reusable elements as exemplarily illustrated in FIG. 15B. The elements along with additional optional text form a content module 1403. FIG. 15C exemplarily illustrates a sample content module defined by elements in the content structure. Depending on the application domain, the content modules are repurposed as shown in the following example:

### Education Domain: Topics, Lessons, and Chapters

### News Magazines Domain: Columns, Articles, and Essays

The content modules define each of multiple content structures. The content structures are grouped together to create a book 1404 or a magazine. A logical aggregation of the content structures results in the creation of the book or magazine. FIG. 15D exemplarily illustrates a page of an online book created by logical aggregation of content structures. In addition, a collection of structured educational content along with unstructured educational content may be grouped together to metaphorically represent a user's homework or assignments along with textbook material. The user is provided with a toolbar 1407 at each stage for creating, editing, tagging, saving, annotating, searching, educational content, etc.

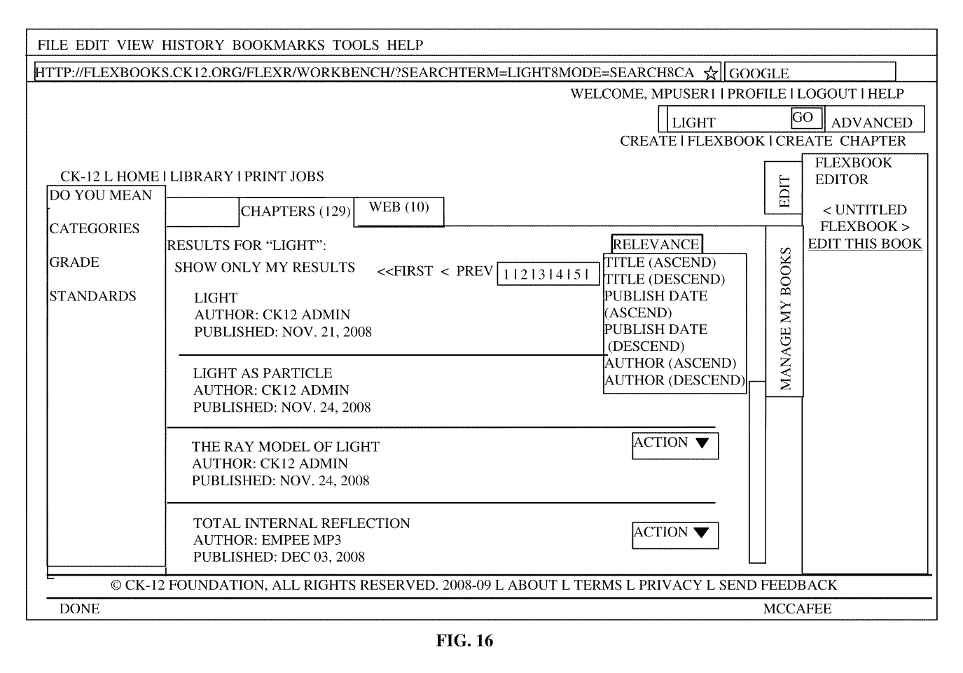

Users 201 can repurpose the content structures either as individual structures or as composites, selected from a repository of content structures filtered by the applied search criteria. These content structures based on how they are created and used, utilize reference counting in order to keep references to where all these content structures are referred and contained within other content structures. The authoring engine 204f, the compilation engine 204d, and the publication module 204e expose the content structures in appropriate levels either as one of an opaque or atomic and transparent or composite objects for editing, revisioning, and versioning purposes. The user will be presented the content structures as books, chapters, or web resources as illustrated in FIG. 16 from which the user can drag and drop desired content manually for creating the online book. In an embodiment, the online book is automatically generated from the relevant content structures. The composite book can then be shared with the user's community for endorsements, ratings, and reviews 1406 or printed 1405 into a physical book.

Consider an example where the computer implemented method and system of compiling and publishing an online book in an online collaborative environment was used to create an online book. In this example, the computer implemented system is herein referred to as a “flexbook system” and the online book is herein referred to as a “flexbook”. The Commonwealth of Virginia under mandate from the Governor of Virginia, along with the National Aeronautics and Space Administration (NASA) conducted a study on updating the Commonwealth's physics curriculum for high schools. The study recommended the need for a Wiki® based custom publishing environment to version and create customized versions of new content that can be adapted for local needs. A team of scientists, professors, and teachers was gathered to creatively collaborate and author the book.

The flexbook system elevated the quality of physics instruction across the Commonwealth by allowing educators to create and compile supplemental materials relating to 21st century physics in an open-source format that can be used to strengthen physics content. The Commonwealth partnered with the Palo Alto, a California-based non-profit organization on this initiative. Palo Alto provided a free, open-source technology platform to facilitate the publication of the newly developed content as a flexbook. The flexbook system technology exercises a specific electronic book (e-book) technology using contemporary physics and laboratories as a focus. A value of the e-book paradigm was that the e-book recognized the dynamical world of science and provided a basis for continuous updating of content to reflect real-world developments. The flexbook system provided valuable contemporary physics curriculum content that supplemented existing Virginia Standard of Learning (SOL). The flexbook system also provided readily available content to all of Virginia's physics teachers. The flexbook system enabled feedback to be provided regarding any needs to make flexbook technology more user-friendly for all users 201. The flexbook system provided concrete examples of some of the 2007 SOL panel recommendations for increasing policy-makers' understanding. The flexbook system provided an idea on the qualitative value of an electronic format (e-format) in replacing some of current textbook purchases. The flexbook system further provided ideas as to whether to continue with further development and releases of the physics flexbook for the instruction side of Virginia Department of Education.

The flexbook system was able to aid in the development of a real learning community among the physics teachers in Virginia. The team members involved in the project could locate and include contemporary and emerging physics content in classes. There are many teachers who lack the background and the initiative to provide students anything beyond SOL, curriculum guidelines, and text. 21^{st} century communications capability offers all teachers the opportunity to better serve their students. The flexbook system was a step forward in understanding how much better users 201 can be. For example, the FairFax County School District plans to use the physics flexbook for the high schools, using a digital format to deliver the contents of the physics flexbook through an online reader on the flexbook system. Using the online reader, the content of the physics flexbook is deliverable via, for example, handheld devices and desktop computers, the iphone of Apple Inc., the ipod of Apple Inc., portable computers, etc.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as micro module database 204i, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of compiling and publishing an online book in an online collaborative environment, comprising the steps of:
collecting requirements from one or more of a plurality of users in said online collaborative environment, wherein said collected requirements comprise one or more of educational subjects, topical subjects, information on syllabus, and an outline;
creating one or more content structures based on said collected requirements;
retrieving educational content, wherein said educational content is one of retrieved from one of a plurality of online sources, created through authoring, and a combination thereof;
compiling said retrieved educational content into said one or more content structures for creation of said online book, wherein said compilation of said retrieved educational content is performed by one of automatic compilation and user declared specification; and
publishing said online book in said online collaborative environment.

2. The computer implemented method of claim 1, further comprising the step of authoring said educational content by said users for inclusion into said online book, wherein said authoring is one of single user authoring and collaborative authoring, wherein said authoring is performed based on formatting instructions and structuring instructions provided in said online collaborative environment.

3. The computer implemented method of claim 1, further comprising the steps of:
gathering said educational content from a plurality of federated repositories pre declared by said users;
uploading said educational content provided by said users in said online collaborative environment;
storing said uploaded educational content in a micro module database; and
translating said stored educational content based on one or more of content, figure, legend, exercise, and answer.

4. The computer implemented method of claim 1, wherein said published online book is manifested in a plurality of formats, wherein one of said formats is a printed physical book.

5. The computer implemented method of claim 1, further comprising the step of maintaining parallel versions and sequential versions of said retrieved educational content and authored educational content in said online collaborative environment.

6. The computer implemented method of claim 1, wherein said educational content comprises one of authored educational content, preexisting online educational content, multimedia learning objects, and a combination thereof.

7. The computer implemented method of claim 1, wherein said one or more content structures are created using one or more of search criteria, applicable context, curriculum guidelines, curriculum standards, and degrees of difficulty.

8. The computer implemented method of claim 1, further comprising the step of masking unsuitable educational content during said compilation of said retrieved educational content.

9. The computer implemented method of claim 1, further comprising the steps of certifying, endorsing, and adapting said retrieved educational content in said online collaborative environment.

10. The computer implemented method of claim 1, further comprising the step of collating said retrieved educational content into different sections based on explicit themes and implicit themes in said online collaborative environment.

11. The computer implemented method of claim 1, further comprising the step of enabling said users to rate, review, recommend, and share said published online book within a social network.

12. The computer implemented method of claim 11, further comprising the steps of:
creating, managing, and enabling sharing of endorsements in said social network; and
enabling user interaction related to content of said published online book.

13. A computer implemented system for compiling and publishing an online book in an online collaborative environment, comprising:
a web interface for enabling one or more of a plurality of users to provide requirements and educational content in said online collaborative environment;
a content collaboration server, comprising:
a requirement collection module for collecting said requirements from one or more of said users in said online collaborative environment, wherein said collected requirements comprise one or more of educational subjects, topical subjects, information on syllabus, and an outline;
a content structure creation engine for creating one or more content structures based on said collected requirements;
a retrieval engine for retrieving educational content, wherein said educational content is one of retrieved from one of a plurality of online sources, created through authoring, and a combination thereof;
a compilation engine for compiling said retrieved educational content into said one or more content structures for creation of said online book, wherein said compilation of said retrieved educational content is performed by one of automatic compilation and user declared specification; and
a publication module for publishing said online book in said online collaborative environment.

14. The computer implemented system of claim 13, wherein said content collaboration server further comprises an authoring engine for enabling said users to author said educational content for inclusion into said online book, wherein said authoring engine provides formatting instructions and structuring instructions in said online collaborative environment to said users for said authoring.

15. The computer implemented system of claim 14, wherein said authoring engine comprises:
a content harvester for gathering said educational content from a plurality of federated repositories pre declared by said users;
a module batch uploader for uploading said educational content provided by said users in said online collaborative environment;
a micro module database for storing said uploaded educational content; and
a translation module for translating said stored educational content based on one or more of content, figure, legend, exercise, and answer.

16. The computer implemented system of claim 13, wherein said content structure creation engine creates said one or more content structures using one or more of search criteria, applicable context, curriculum guidelines, curriculum standards, and degrees of difficulty.

17. The computer implemented system of claim 13, wherein said content collaboration server further comprises a versioning engine for maintaining parallel versions and sequential versions of said retrieved educational content and authored educational content in said online collaborative environment.

18. The computer implemented system of claim 13, wherein said content collaboration server further comprises a database storage and archiving engine for storing said educational content separately from metadata associated with said educational content.

19. The computer implemented system of claim 13, wherein said content collaboration server further comprises a social network module for performing the steps of:
creating, managing, and enabling sharing of endorsements in a social network; and
enabling user interaction related to content of said published online book.

20. A computer program product comprising computer executable instructions embodied in a computer-readable medium, wherein said computer program product comprises:
a first computer parsable program code for collecting requirements from one or more of a plurality of users in an online collaborative environment, wherein said collected requirements comprise one or more of educational subjects, topical subjects, information on syllabus, and an outline;
a second computer parsable program code for creating one or more content structures based on said collected requirements;
a third computer parsable program code for retrieving educational content, wherein said educational content is one of retrieved from one of a plurality of online sources, created through authoring, and a combination thereof;
a fourth computer parsable program code for compiling said retrieved educational content into said one or more content structures for creation of said online book, wherein said compilation of said retrieved educational content is performed by one of automatic compilation and user declared specification; and
a fifth computer parsable program code for publishing said online book in said online collaborative environment.

21. The computer program product of claim 20, further comprising a sixth computer parsable program code for creating said one or more content structures using one or more of search criteria, applicable context, curriculum guidelines, curriculum standards, and degrees of difficulty.
